(19) United States
(12) Patent Application Publication
(10) Pub. No.: US 2026/0178228 A1
(43) Pub. Date: Jun. 25, 2026

(54) DATA READING METHOD AND MEMORY CONTROLLER

(71) Applicant: Hefei Kaimeng Technology Co., Ltd., Anhui (CN)

(72) Inventors: Zhiwei Li, Anhui (CN); Chong PENG, Anhui (CN); Xin WANG, Anhui (CN); Xuhui Cheng, Anhui (CN); Wan Jun HONG, Anhui (CN); Yang Zhang, Anhui (CN); Jian HU, Anhui (CN)

(73) Assignee: Hefei Kaimeng Technology Co., Ltd., Anhui (CN)

(21) Appl. No.: 19/386,165

(22) Filed: Nov. 11, 2025

(30) Foreign Application Priority Data
Dec. 24, 2024 (CN) 202411917646.6

(51) Int. Cl. G06F 3/06

(52) U.S. Cl. CPC G06F 3/0659; G06F 3/0613; G06F 3/0656; G06F 3/0679

(57) ABSTRACT

The present disclosure discloses a data reading method and a memory controller. The method comprises: storing a plurality of read commands into cache pools corresponding to different chip enable pins respectively; when a preset condition is met, performing a pre-sorting operation on the read commands in the cache pools to group the read commands into a plurality of read command groups, wherein read commands in each group correspond to different planes and memory cells belong to a same memory cell type; generating an execution command sequence according to the read command groups; and completing a parallel read operation based on the execution command sequence. The present disclosure improves the read speed of an SSD and the data channel utilization rate by optimizing the sorting and grouping of read commands.

### CROSS-REFERENCE TO RELATED APPLICATION

This application claims the priority benefit of China application serial no. 202411917646.6, filed on Dec. 24, 2024. The entirety of the above-mentioned patent application is hereby incorporated by reference herein and made a part of this specification.

### BACKGROUND

### Technical Field

The present invention relates to the field of storage technology, and more specifically, to a data reading method based on Asynchronous Independent Plane Read (AIPR) and a memory controller, adapted for a storage device configured with a rewritable non-volatile memory module.

### Description of Related Art

A non-volatile memory is a type of computer memory that can retain stored data even when the power is turned off. It has advantages such as data non-volatility, power saving, small size, and no mechanical structure, and is widely used in various electronic devices.

A common non-volatile memory is a memory configured with NAND Flash (such as a solid-state drive), which has characteristics such as high read/write speeds and does not require a mechanical structure for data access.

The storage organization of a flash memory chip usually includes Die/Logical Unit Number (LUN), Plane, Block, and Page. Among them, the LUN is the smallest unit in the flash memory that can execute commands independently. A Die/LUN may contain a plurality of planes, and each plane is composed of hundreds or even thousands of blocks.

Currently, an SSD mainly performs operations such as reading, writing, and erasing on the flash memory through a command-plus-address method. For a read operation, mainstream methods include Single-plane read (SP), Multi-plane read (MP), and Asynchronous Independent Plane Read (AIPR).

An SP read operation performs a read operation on only one plane in one chip at a time. Although MP can perform operations on a plurality of planes in one chip, it requires setting the same page address. AIPR is a more advanced MP read operation that can perform independent read operations on different pages of a plurality of planes of the same chip. Compared to the MP read operation, it significantly improves the read rate of the SSD. However, how to maximize the utilization of AIPR is still a problem that the industry urgently needs to solve.

### SUMMARY

An objective of the present invention is to provide a data reading method and a memory controller, aiming to solve the problem of low execution efficiency of AIPR commands in the prior art, fully utilize the multi-plane concurrent reading capability of a flash memory chip, and improve the command execution rate and data channel utilization rate of a storage device.

One or more embodiments of the present invention provide a data reading method based on Asynchronous Independent Plane Read (AIPR), adapted for a storage device configured with a rewritable non-volatile memory module. The method includes: storing a plurality of read commands from a host system into one or more cache pools respectively, wherein the one or more cache pools respectively correspond to different chip enable pins; when a preset condition is met, performing a pre-sorting operation on a plurality of first read commands in a first cache pool among the one or more cache pools to group the plurality of first read commands into a plurality of read command groups, wherein one or more second read commands belonging to a same read command group respectively correspond to different planes of a same chip in the storage device, and memory cells corresponding to each of the one or more second read commands belong to a same memory cell type; generating an execution command sequence corresponding to the first cache pool according to the plurality of read command groups of the first cache pool; and executing a plurality of commands according to the execution command sequence to complete a parallel read operation corresponding to the plurality of first read commands.

In one or more embodiments of the present invention, the preset condition includes at least one of the following: a number of the plurality of first read commands stored in the first cache pool reaches a predetermined threshold; or a waiting time of a first read command earliest stored in the first cache pool reaches a predetermined time threshold.

In one or more embodiments of the present invention, the method further includes: obtaining a physical address of each read command according to recorded mapping information; and obtaining physical characteristics of the physical address of the read command according to the physical address of the read command, wherein the physical characteristics include the chip enable pin, the plane, a chip, and the memory cell type.

In one or more embodiments of the present invention, a step of performing the pre-sorting operation includes: grouping the plurality of first read commands according to the memory cell type corresponding to each of the plurality of first read commands to obtain one or more memory cell type command groups, wherein one or more first read commands belonging to a same memory cell type command group correspond to a same memory cell type; grouping the one or more first read commands within the same memory cell type command group according to the chip corresponding to each of the one or more first read commands within the same memory cell type command group to obtain one or more chip command groups, wherein one or more first read commands belonging to a same chip command group correspond to a same chip; and compiling one or more second read commands respectively pointing to different planes within each chip command group into a same read command group to obtain the plurality of read command groups, wherein a processing order of the one or more second read commands within each read command group is set based on an order of corresponding planes.

In one or more embodiments of the present invention, a plurality of commands within the execution command sequence include the following types: a read trigger command, a polling command, and a data access command, wherein a step of generating the execution command sequence includes: performing a command sequence generation operation on each read command group in sequence according to a compilation order of the plurality of read command groups, wherein when performing the command sequence generation operation on a current read command group among the plurality of read command groups, generating the read trigger command, the polling command, and the data access command corresponding to each current second read command according to a processing order of one or more current second read commands of the current read command group to obtain a first command sequence corresponding to the current read command group; and storing the generated first command sequence into the execution command sequence.

In one or more embodiments of the present invention, the method further includes: when performing the command sequence generation operation on the current read command group among the plurality of read command groups, checking a next read command group sorted after the current read command group to obtain the plane pointed to by each of one or more next second read commands in the next read command group and a working state of the plane, wherein the working state includes an idle state and a busy state; and adjusting a processing order of the one or more next second read commands according to the working state of the plane pointed to by each of the one or more next second read commands.

In one or more embodiments of the present invention, a step of obtaining the plane pointed to by each of the one or more next second read commands in the next read command group and the working state of the plane includes: if a first plane pointed to by one of the one or more next second read commands is not pointed to by the one or more current second read commands in the current read command group, determining that the working state of the first plane is the idle state; and if a second plane pointed to by one of the one or more next second read commands has been pointed to by the one or more current second read commands in the current read command group, determining that the working state of the second plane is the busy state.

In one or more embodiments of the present invention, a step of adjusting the processing order of the one or more next second read commands includes: prioritizing processing of a target next second read command corresponding to the first plane in the idle state among the one or more next second read commands.

In one or more embodiments of the present invention, the method further includes: when performing the command sequence generation operation on the current read command group among the plurality of read command groups, checking a next read command group sorted after the current read command group to obtain the plane pointed to by each of one or more next second read commands in the next read command group and a working state of the plane, wherein the working state includes an idle state and a busy state; obtaining a target next second read command corresponding to a target plane that is in the idle state among the one or more next second read commands; generating a target read trigger command, a target polling command, and a target data access command corresponding to the target next second read command; inserting the target read trigger command into the first command sequence; and inserting the target polling command and the target data access command after the first command sequence.

In one or more embodiments of the present invention, the method further includes: when performing the command sequence generation operation on the current read command group among the plurality of read command groups, checking a next read command group sorted after the current read command group to obtain the plane pointed to by each of one or more next second read commands in the next read command group; and when a target plane pointed to by a target next second read command among the one or more next second read commands is different from all the planes respectively corresponding to all the current second read commands, generating a target read trigger command, a target polling command, and a target data access command corresponding to the target next second read command; inserting the target read trigger command into the first command sequence; and inserting the target polling command and the target data access command after the first command sequence.

In one or more embodiments of the present invention, a step of generating the read trigger command, the polling command, and the data access command corresponding to each current second read command according to the processing order of the one or more current second read commands of the current read command group includes: generating a first read trigger command corresponding to each current second read command one by one according to the processing order of the one or more current second read commands; generating a pair of a first polling command and a first data access command corresponding to each current second read command one by one according to the processing order of the one or more current second read commands; and for the one or more current second read commands, store their one or more first read trigger commands and one or more pairs of first polling commands and first data access commands as the first command sequence in the execution command sequence.

In one or more embodiments of the present invention, a step of storing the generated first command sequence into the execution command sequence includes: checking whether there is a previous read command group sorted before the current read command group. If the previous read command group exists, performing the following steps: obtaining a second command sequence of the previous read command group, wherein the second command sequence includes one or more second read trigger commands and one or more pairs of a second polling command and a second data access command corresponding to one or more previous second read commands of the previous read command group; inserting the one or more first read trigger commands respectively after the second data access commands corresponding to a same plane in sequence according to the processing order of the one or more current second read commands; and storing the one or more pairs of the first polling command and the first data access command in sequence according to the processing order of the one or more current second read commands.

In one or more embodiments of the present invention, performing the command sequence generation operation on the plurality of read command groups includes: performing a command conversion on each second read command of each read command group according to the compilation order of the plurality of read command groups, wherein the command conversion includes generating a read trigger command, a polling command, and a data access command according to a corresponding second read command. Wherein, for the current read command group on which the command conversion is being performed: generating a read trigger command corresponding to the current second read command for each current second read command of the current read command group on which the command conversion has not yet been performed; generating a corresponding polling command and a data access command for each read trigger command; for each read trigger command, obtaining the plane corresponding to the read trigger command, and checking whether there is a target read command pointing to a same plane in a next read command group; if the target read command pointing to the same plane exists, generating a corresponding target read trigger command based on the target read command of the next read command group, inserting the target read trigger command after the data access command corresponding to the read trigger command, and generating a target polling command and a target data access command corresponding to the target read trigger command; and if the target read command pointing to the same plane does not exist, completing the command conversion for all current second read commands of the current read command group, and taking the next read command group as a new current read command group to perform a corresponding command conversion, wherein if it is checked that the next read command group does not exist, completing generation of the execution command sequence.

In one or more embodiments of the present invention, performing the command sequence generation operation on the plurality of read command groups includes: performing a command conversion on each second read command of each read command group according to the compilation order of the plurality of read command groups, wherein the command conversion includes generating a read trigger command, a polling command, and a data access command according to a corresponding second read command. Wherein, for the current read command group on which the command sequence conversion is being performed: performing the command conversion on each current second read command of the current read command group on which the command conversion has not yet been performed, including: if a read trigger command of a current second read command on which the command conversion is being performed has not yet been generated, generating a read trigger command corresponding to the current second read command, and generating a corresponding polling command and a data access command for the read trigger command; if the read trigger command of the current second read command on which the command conversion is being performed has already been generated, generating a corresponding polling command and a data access command for the read trigger command; after generating the corresponding polling command and the data access command, obtaining the plane corresponding to the read trigger command, and checking whether there is a target read command pointing to a same plane in a next read command group; wherein if the target read command pointing to the same plane exists, generating a corresponding target read trigger command based on the target read command of the next read command group, inserting the target read trigger command after the data access command corresponding to the read trigger command, and completing the command conversion of the current second read command; and wherein if the target read command pointing to the same plane does not exist, completing the command conversion of the current second read command, setting a next read command group as a new current read command group, and repeating the above steps to perform the command conversion on a new current read command.

One or more embodiments of the present invention provide a memory controller for controlling a storage device configured with a rewritable non-volatile memory module. The memory controller includes: a memory interface control circuit, for electrically connecting to the rewritable non-volatile memory module; a data management circuit, electrically connected to a connection interface circuit of the storage device, for receiving data and commands from a host system via the connection interface circuit; a buffer memory, for caching data; and a processor, electrically connected to the memory interface control circuit, the data management circuit, and the buffer memory. Wherein the processor is configured to: store a plurality of read commands from the host system into one or more cache pools of the buffer memory respectively, wherein the one or more cache pools respectively correspond to different chip enable pins, and a plurality of read commands within a same cache pool all point to the chip enable pin corresponding to the cache pool to which it belongs; when a preset condition is met, perform a pre-sorting operation on a plurality of first read commands in a first cache pool among the one or more cache pools to group the plurality of first read commands into a plurality of read command groups, wherein one or more second read commands belonging to a same read command group respectively correspond to different planes of the storage device of the rewritable non-volatile memory module, and memory cells corresponding to each of the one or more second read commands belong to a same memory cell type; generate an execution command sequence corresponding to the first cache pool according to the plurality of read command groups of the first cache pool; and execute a plurality of commands according to the generated execution command sequence to complete a parallel read operation corresponding to the plurality of first read commands.

Based on the foregoing, the data reading method and the memory controller provided by the embodiments of the present invention may have beneficial effects including: fully utilizing the parallel reading capability of the AIPR technology by pre-sorting and grouping read commands, so as to improve the read speed of an SSD; improving the utilization rate of a data channel by generating an optimized execution command sequence; avoiding performance loss caused by differences in read times of different types of memory cells by considering the memory cell type of the memory cells; and improving the utilization rate of idle planes and further optimizing the overall read performance by dynamically adjusting the command execution order.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of a host system and a storage device according to an embodiment of the present invention.

FIG. 2 is a flowchart of a data reading method according to an embodiment of the present invention.

FIG. 3 is a schematic diagram of caching a plurality of read commands into a plurality of cache pools according to an embodiment of the present invention.

FIG. 4 is a schematic diagram of a pre-sorting operation according to an embodiment of the present invention.

FIG. 5 is a schematic diagram of a command conversion according to an embodiment of the present invention.

FIG. 6 is a schematic diagram of performing a command conversion on a read command group to generate a first command sequence according to an embodiment of the present invention.

FIG. 7 is a schematic diagram of inserting an AIPR command of a read command group into a command sequence of a previous read command group according to an embodiment of the present disclosure.

FIG. 8 is a schematic diagram of storing a polling command and a data access command of a read command group into an execution command sequence according to an embodiment of the present disclosure.

FIG. 9 is a command execution timing diagram of an execution command sequence according to an embodiment of the present disclosure.

FIG. 10 is a schematic diagram of generating a corresponding execution command sequence according to a plurality of read command groups according to an embodiment of the present disclosure.

FIG. 11 is a schematic diagram of generating a corresponding execution command sequence according to a plurality of read command groups according to another embodiment of the present disclosure.

FIG. 12 is a command execution timing diagram of an execution command sequence according to another embodiment of the present disclosure.

### DESCRIPTION OF THE EMBODIMENTS

Reference will now be made in detail to the exemplary embodiments of the present disclosure, examples of which are illustrated in the accompanying drawings. Wherever possible, the same reference numerals are used in the drawings and the description to refer to the same or similar parts.

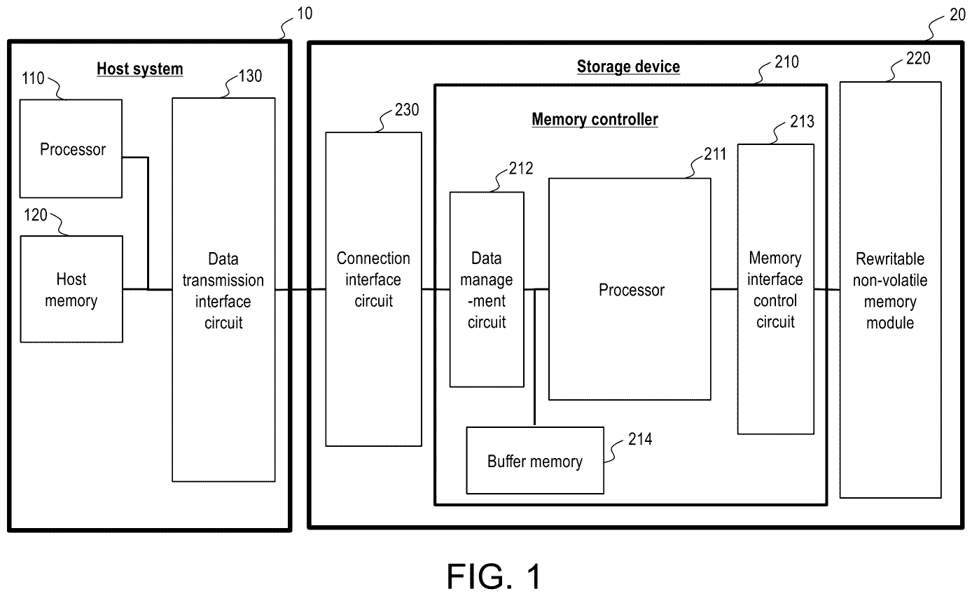

FIG. 1 is a block diagram of a host system and a storage device according to an embodiment of the present disclosure. Referring to FIG. 1, the host system 10 is, for example, a personal computer, a notebook computer, or a server. The host system 10 includes a processor 110 (also referred to as a second processor), a host memory 120, and a data transfer interface circuit 130. In this embodiment, the processor 110 is coupled (also referred to as electrically connected) to the host memory 120 and the data transfer interface circuit 130. In another embodiment, the processor 110, the host memory 120, and the data transfer interface circuit 130 are electrically connected to each other through a system bus. In this embodiment, the processor 110, the host memory 120, and the data transfer interface circuit 130 may be disposed on a motherboard of the host system 10.

The storage device 20 includes a memory controller 210, a rewritable non-volatile memory module 220, and a connection interface circuit 230. The memory controller 210 includes a processor 211 (also referred to as a first processor), a data management circuit 212, and a memory interface control circuit 213.

In this embodiment, the host system 10 is electrically connected to the storage device 20 through the data transfer interface circuit 130 and the connection interface circuit 230 of the storage device 20 to perform data access operations. For example, the host system 10 may store data to the storage device 20 or read data from the storage device 20 via the data transfer interface circuit 130.

In this embodiment, the number of the data transfer interface circuits 130 may be one or more. Through the data transfer interface circuit 130, a motherboard may be electrically connected to the storage device 20 via a wired or wireless manner. The storage device 20 may be, for example, a USB flash drive, a memory card, a solid state drive (SSD), or a wireless memory storage device. The wireless memory storage device may be, for example, a Near Field Communication (NFC) memory storage device, a Wi-Fi memory storage device, a Bluetooth memory storage device, or a Bluetooth Low Energy memory storage device (e.g., iBeacon), or other memory storage devices based on various wireless communication technologies. In addition, the motherboard may also be electrically connected to various I/O devices such as a Global Positioning System (GPS) module, a network interface card, a wireless transmission device, a keyboard, a screen, and a speaker through the system bus.

In this embodiment, the data transfer interface circuit 130 and the connection interface circuit 230 are interface circuits compatible with the Peripheral Component Interconnect Express (PCI Express) standard. Moreover, data transmission between the data transfer interface circuit 130 and the connection interface circuit 230 is performed using the Non-Volatile Memory express (NVMe) communication protocol.

In addition, in another embodiment, the connection interface circuit 230 may be packaged in a single chip with the memory controller 210, or the connection interface circuit 230 is disposed outside a chip that includes the memory controller 210.

In this embodiment, the host memory 120 is used to temporarily store commands or data executed by the processor 110. For example, in this embodiment, the host memory 120 may be a dynamic random access memory (DRAM), a static random access memory (SRAM), or the like. However, it must be understood that the present disclosure is not limited thereto, and the host memory 120 may also be other suitable types of memory.

The memory controller 210 is used to execute a plurality of logic gates or control commands implemented in a hardware form or a firmware form, and to perform operations such as data writing, reading, and erasing in the rewritable non-volatile memory module 220 according to commands from the host system 10.

More specifically, the processor 211 in the memory controller 210 is a hardware with computing capabilities, used to control the overall operation of the memory controller 210. Specifically, the processor 211 is programmed by a plurality of control commands/program codes, and when the storage device 20 is in operation, these control commands/program codes are executed to perform operations such as data writing, reading, and erasing. In addition, in this embodiment, the control commands/program codes may be further executed to implement the data reading method provided by the present disclosure. The control commands/program codes corresponding to the data reading method may be further implemented as circuit units in a hardware form to implement the data reading method provided by the present disclosure.

It is worth mentioning that, in this embodiment, the processor 110 and the processor 211 are, for example, a central processing unit (CPU), a micro-processor, or another programmable processing unit, a digital signal processor (DSP), a programmable controller, an application-specific integrated circuit (ASIC), a programmable logic device (PLD), or other similar circuit components, and the present disclosure is not limited thereto.

In this embodiment, as described above, the memory controller 210 further includes the data management circuit 212 and the memory interface control circuit 213. It should be noted that operations performed by the various components of the memory controller 210 may also be regarded as operations performed by the memory controller 210.

The data management circuit 212 is electrically connected to the processor 211, the memory interface control circuit 213, and the connection interface circuit 230. The data management circuit 212 is used to receive instructions from the processor 211 to perform data transmission. For example, it reads data from the host system 10 (e.g., the host memory 120) via the connection interface circuit 230, and writes the read data to the rewritable non-volatile memory module 220 via the memory interface control circuit 213 (e.g., performing a write operation according to a write command from the host system 10). As another example, it reads data from one or more physical units of the rewritable non-volatile memory module 220 via the memory interface control circuit 213 (the data may be read from one or more memory cells in the one or more physical units), and writes the read data to the host system 10 (e.g., the host memory 120) via the connection interface circuit 230 (e.g., performing a read operation according to a read command from the host system 10). In another embodiment, the data management circuit 212 may also be integrated into the processor 211.

The memory interface control circuit 213 is used to receive instructions from the processor 211 and cooperate with the data management circuit 212 to perform a writing (also referred to as programming) operation, a reading operation, or an erasing operation on the rewritable non-volatile memory module 220.

In addition, data to be written to the rewritable non-volatile memory module 220 is converted by the memory interface control circuit 213 into a format acceptable to the rewritable non-volatile memory module 220. Specifically, if the processor 211 is to access the rewritable non-volatile memory module 220, the processor 211 sends a corresponding command sequence to the memory interface control circuit 213 to instruct the memory interface control circuit 213 to perform a corresponding operation. For example, these command sequences may include a write command sequence for instructing to write data, a read command sequence for instructing to read data, an erase command sequence for instructing to erase data, and corresponding command sequences for instructing various memory operations. These command sequences may include one or more signals, or data on a bus. These signals or data may include command codes or program codes. For example, a read command sequence will include information such as a read identifier, a memory address, and a physical address.

In the present disclosure, an execution command sequence (also referred to as an AIPR command sequence) is a specially optimized read command sequence, generated by a processor and sent to a memory interface control circuit. This type of command sequence fully utilizes the characteristics of the Asynchronous Independent Plane Read (AIPR) technology, and is capable of simultaneously performing read operations on different pages of a plurality of planes. Specifically, the execution command sequence includes a plurality of AIPR commands (also referred to as read trigger commands), polling commands, and Direct Memory Access (DMA) commands. Each AIPR command includes specific information such as a specific command code, a target plane identifier, and a physical page address. The polling command is used to check a completion status of a read operation, while the DMA command (also referred to as a data access command) is used to transfer the read data to a specified memory location. These commands are carefully sorted and organized to maximize parallel read efficiency. For example, the AIPR command sequence may first send a plurality of AIPR commands targeting different planes, and then alternately send polling commands and DMA commands to achieve overlapping execution of read operations and data transfers. After receiving such an optimized AIPR command sequence, the memory interface control circuit converts it into specific signals and timings acceptable to the rewritable non-volatile memory module, so as to implement efficient parallel read operations. The generation method of the AIPR command sequence provided by the data reading method of the present disclosure will be described below through a plurality of embodiments and corresponding drawings.

In the present disclosure, the memory controller 210 establishes a logical-to-physical address mapping table and a physical-to-logical address mapping table to record mapping relationships between logical addresses of logical units (e.g., logical blocks, logical pages, or logical columns) allocated to the rewritable non-volatile memory module 220 and physical addresses of physical units (e.g., physical erase units/physical blocks, physical pages, physical columns). In other words, the memory controller 210 may look up a physical unit mapped by a logical unit through the logical-to-physical address mapping table (also referred to as a logical-to-physical mapping table) (e.g., look up a physical page mapped by a logical page; look up a physical address mapped by a logical address), and the memory controller 210 may look up a logical unit mapped by a physical unit through the physical-to-logical address mapping table (also referred to as a physical-to-logical mapping table) (e.g., look up a logical page mapped by a physical page; look up a logical address mapped by a logical address).

In an embodiment, the memory controller 210 further includes a buffer memory 214. The buffer memory is electrically connected to the processor 211 and is used to temporarily store data and commands from the host system 10, data from the rewritable non-volatile memory module 220, or other system data for managing the storage device 20 (e.g., various mapping tables, index tables, address lists, a plurality of cache pools for caching a plurality of read commands, a result pool for storing pre-sorting results, one or more AIPR command sequences, and other information associated with the method), so that the processor 211 can quickly access the data, commands, or system data from the buffer memory 214.

The rewritable non-volatile memory module 220 is electrically connected to the memory controller 210 (the memory interface control circuit 213) and is used to store data written by the host system 10.

In this embodiment, the rewritable non-volatile memory module 220 has a plurality of word lines, wherein each of the plurality of word lines is electrically connected to a plurality of memory cells, also referred to as a column (also referred to as a physical column). A plurality of columns on the same word line form a physical programming unit (also referred to as a physical page). Each physical page corresponds to a physical address, which is used to record the location of the data stored in the physical page. In addition, a plurality of physical pages may form a physical block (also referred to as a physical erase unit). Each memory die (chip) of a plurality of memory dies of the rewritable non-volatile memory module has a plurality of planes, and each plane has a plurality of physical blocks. It should be noted that the present disclosure does not limit the size of each physical page and logical page.

A Channel (CH) pin (also referred to as a physical channel) is a set of physical pins in the rewritable non-volatile memory module 220, which is responsible for receiving and transmitting data and commands.

A Chip Enable (CE) pin is used to select or deselect a memory chip. Each CE pin corresponds to a physical chip (memory chip). If a certain chip enable pin is in an active state, then the corresponding physical chip is selected.

In the architecture of a flash memory, a Die is the most basic physical unit, usually corresponding to an independent storage area on a chip. Each chip may contain one or more Logical Unit Numbers (LUNs), and an LUN is the smallest unit that can execute commands independently. Each LUN is further divided into a plurality of planes, and a plane is the basic unit for parallel operations, capable of performing read and write operations simultaneously to improve performance.

A memory cell type may be used to represent the number of bits that each memory cell can store. Common types include SLC (Single-Level Cell, where each cell stores 1 bit), MLC (Multi-Level Cell, where each cell stores 2 bits), TLC (Triple-Level Cell, where each cell stores 3 bits), etc. Different memory cell types differ in aspects such as storage density, read/write speed, and endurance, affecting the overall performance and characteristics of the flash memory.

In the hierarchical structure of a flash memory, a Chip Enable (CE) pin is used to select and activate a specific memory chip. Each CE may control one or more Dies. Each chip is an independent physical storage unit and may contain one or more Logical Unit Numbers (LUNs). An LUN is the smallest unit that can execute commands independently, and each LUN is further divided into a plurality of planes for implementing parallel operations. A plane is composed of a plurality of blocks, and each block in turn contains a plurality of pages. A page is the basic unit for read and write operations and is composed of a plurality of memory cells. The type of the memory cells (e.g., SLC, MLC, TLC) determines the number of bits that each cell can store. This hierarchical structure enables the flash memory to implement parallel operations at different levels, so as to improve overall performance. For example, the AIPR technology allows for independent read operations to be performed simultaneously on different planes of the same LUN, fully utilizing this structural characteristic.

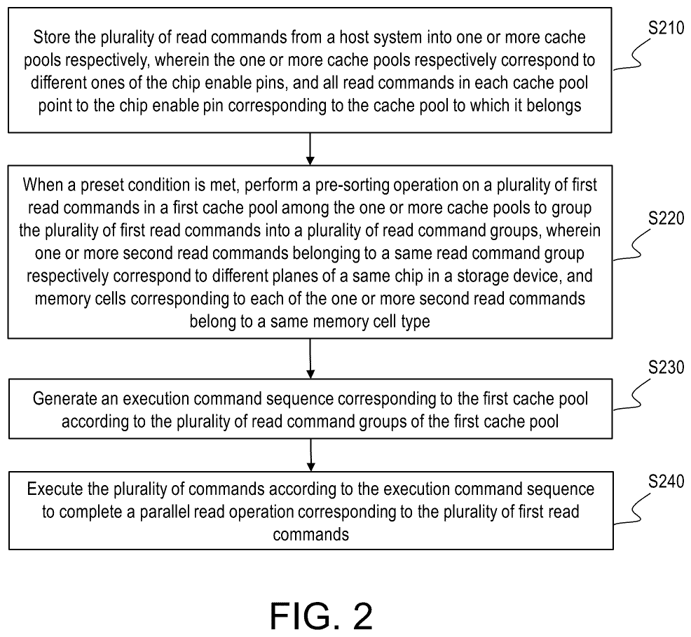

FIG. 2 is a flowchart of a data reading method according to an embodiment of the present disclosure.

Referring to FIG. 2, the present disclosure provides a data reading method based on Asynchronous Independent Plane Read (AIPR), and the method includes the following main steps:
Step S210: Store the plurality of read commands from the host system into one or more cache pools respectively, wherein the one or more cache pools respectively correspond to different ones of the chip enable pins, and all read commands in each cache pool point to the chip enable pin corresponding to the cache pool to which it belongs.

In this embodiment, the memory controller 210 receives a plurality of read commands from the host system 10 and allocates these commands to different cache pools according to the chip enable pin corresponding to each read command. These cache pools may be a part of the buffer memory 214. When a number of commands in a certain cache pool reaches a predetermined threshold or a waiting time of a command earliest stored reaches a predetermined time threshold, the processor 211 of the memory controller 210 performs a pre-sorting operation on the commands in the cache pool.

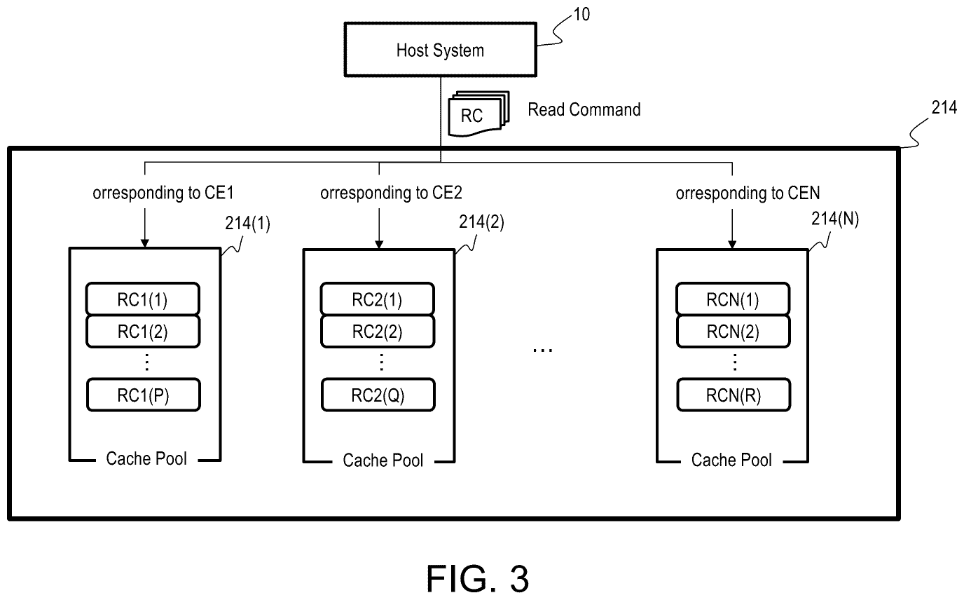

FIG. 3 is a schematic diagram of caching a plurality of read commands into a plurality of cache pools according to an embodiment of the present disclosure. In an embodiment, the present disclosure provides a method for caching a plurality of read commands into a plurality of cache pools. As shown in FIG. 3, the method involves an interaction between the host system 10 and the buffer memory 214 of the memory controller 210 of the storage device 20.

The host system 10 sends a plurality of read commands (RCs) to the storage device 20. The buffer memory 214 includes a plurality of cache pools, and each cache pool corresponds to a specific chip enable (CE) pin. Specifically, the cache pool 214(1) corresponds to the chip enable pin CE1, the cache pool 214(2) corresponds to the chip enable pin CE2, and so on, until the cache pool 214(N) corresponds to the chip enable pin CEN. This one-to-one mapping relationship ensures that the read commands stored in each cache pool all point to the same chip enable pin.

When the memory controller 210 receives the read commands, it stores these commands into corresponding cache pools respectively according to the chip enable pin corresponding to each read command. For example, read commands RC1(1), RC1(2), . . . , RC1(P) related to CE1 are stored in the cache pool 214(1). Similarly, read commands RC 2(1), RC2(2), . . . , RC2(Q) related to CE2 are stored in the cache pool 214(2), and so on.

This storage method has several important advantages:
(1) Command isolation: Commands for different chip enable pins are stored separately, avoiding confusion and conflicts.
(2) Preparation for parallel processing: This lays a foundation for subsequent AIPR operations, because the commands in each cache pool can be independently pre-sorted and optimized.
(3) Resource allocation: This allows the memory controller 210 to manage and allocate resources more effectively, because it can process the command queue for each chip enable pin separately.
(4) Flexibility: This structure supports dynamically adding or removing chip enable pins simply by correspondingly increasing or decreasing the cache pools.

In an embodiment, the data reading method of the present disclosure further includes steps of performing detailed processing and analysis on the read commands to prepare for the subsequent pre-sorting operation and generation of the AIPR command sequence. Specifically, the method includes the following steps:
First, when storing a plurality of read commands into one or more cache pools respectively, the memory controller 210 sequentially sets a unique sequence number for each read command within each cache pool. For example, for the read commands in the cache pool 214(1), sequence numbers (e.g., “1”, “2”, . . . , “P”) may be assigned in the order of RC1(1), RC1(2), . . . , RC1(P). This sequence number assignment mechanism helps to track the receiving order of the commands and maintain the timing relationship of the commands in subsequent processing.

Second, the processor 211 obtains a physical address of each read command according to recorded mapping information (e.g., a logical-to-physical mapping table). This step involves a process of translating a logical address to a physical address, which is usually completed by a flash translation layer (FTL). The mapping information is usually stored in the buffer memory 214 or in a dedicated cache of the processor 211.

Finally, based on the obtained physical address, the processor 211 further obtains physical characteristics of the physical address. These physical characteristics include:
Chip enable (CE) pin: Indicates the CE to which this physical address corresponds.
   Plane: Identifies the specific plane location of this physical address within a chip.
   Die: Indicates the chip where this physical address is located.
   Memory cell type: Indicates the type of the memory cell to which this physical address corresponds, such as SLC, MLC, or TLC.

The chip enable pin and chip information help to determine to which specific physical device a command should be sent. The plane information is extremely important for the parallel execution of AIPR operations because it allows the system (the memory controller 210) to simultaneously access different planes on the same chip. The memory cell type information helps to optimize read timing because different types of memory cells require different read times.

The aforementioned pre-processing steps provide an information basis for the subsequent pre-sorting operation. For example, when performing the pre-sorting, commands pointing to different planes can be grouped according to the plane information, while considering the memory cell type to ensure that commands in the same group have similar read times. This not only improves the degree of parallelism of AIPR operations, but also optimizes the overall read efficiency.

In addition, this information also provides necessary parameters for the generation of the AIPR command sequence. When generating an AIPR command, the system can precisely specify the read command, a target chip, a plane, and read timing.

Returning to FIG. 2, in step S220, when a preset condition is met, the processor 211 performs a pre-sorting operation on a plurality of first read commands in a first cache pool among the one or more cache pools to group the plurality of first read commands into a plurality of read command groups, wherein one or more second read commands belonging to a same read command group respectively correspond to different planes of a same chip in the storage device, and memory cells corresponding to each of the one or more second read commands belong to a same memory cell type.

The purpose of the pre-sorting operation is to group the read commands such that commands within the same group respectively correspond to different planes, and the memory cells to which these commands correspond belong to the same memory cell type (e.g., SLC, MLC, or TLC). This grouping strategy can fully utilize the parallel reading capability of the AIPR technology, while also considering the read characteristics of different memory cell types.

In an embodiment, a step of performing the pre-sorting operation includes: grouping the plurality of first read commands according to the memory cell type corresponding to each of the plurality of first read commands to obtain one or more memory cell type command groups, wherein one or more first read commands belonging to a same memory cell type command group correspond to a same memory cell type; grouping the one or more first read commands within the same memory cell type command group according to the chip corresponding to each of the one or more first read commands within the same memory cell type command group to obtain one or more chip command groups, wherein one or more first read commands belonging to a same chip command group correspond to a same chip; and compiling one or more second read commands respectively pointing to different planes within each chip command group into a same read command group to obtain the plurality of read command groups, wherein a processing order of the one or more second read commands within each read command group is set based on an order of corresponding planes. This multi-level grouping strategy ensures that commands within the same group have similar execution characteristics, which is beneficial for subsequent AIPR operations.

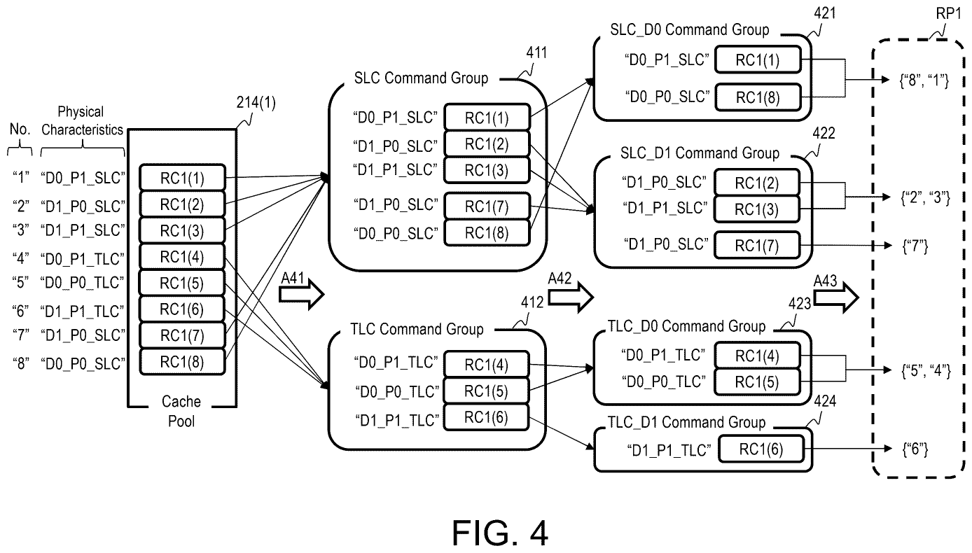

The following uses the pre-sorting operation shown in FIG. 4 as an example to describe this process in detail. FIG. 4 is a schematic diagram of a pre-sorting operation according to an embodiment of the present disclosure.

In FIG. 4, it is assumed that when the preset condition is met, the cache pool 214(1) contains 8 read commands, RC1(1) to RC 1(8), and each command has a sequence number and corresponding physical characteristics. The physical characteristics include a chip number (D0 or D1), a plane number (P0 or P1), and a memory cell type (SLC or TLC). For example, the physical characteristic “D0_P1_SLC” of the read command RC1(1) indicates that: the physical address corresponding to the read command RC1(1) points to the chip D0 and the plane P1 within the chip D0, and the type of the memory cell at this physical address is SLC.

The first step of the pre-sorting operation (indicated by arrow A41) is to group according to the memory cell type. In an embodiment, the present disclosure further optimizes the pre-sorting operation by considering that the time (tR) required to perform a read operation varies for different flash memory types. This maximizes the utilization rate of each plane and avoids a situation where an excessively long read time of a certain plane affects the overall command execution efficiency. The specific implementation is as follows:
(1) Flash memory type identification: When grouping and sorting the read commands, the system first determines which flash memory type (e.g., SLC, MLC, TLC, etc.) the physical address pointed to by each read command belongs to.
(2) Grouping by same type: Only read commands belonging to the same flash memory type are compiled into the same command group combination. For example, an SLC command group 411 includes read commands RC1(1), RC1(2), RC1(3), RC1(7), and RC1(8), and the physical addresses of these read commands all correspond to the SLC memory cell type. A TLC command group 412 includes read commands RC1(4), RC1(5), and RC1(6), and the physical addresses of these read commands all correspond to the TLC memory cell type.

The second step (indicated by arrow A42) is to group by chip within each memory cell type group:

For the SLC command group 411, it may be grouped into an SLC_D0 command group 421 and an SLC_D1 command group 422. For example: the SLC_D0 command group 421 includes read commands RC1(1) and RC1(8), and the physical addresses of these read commands all correspond to the chip D0. The SLC_D1 command group 422 includes read commands RC1(2), RC1(3), and RC1(7), and the physical addresses of these read commands all correspond to the chip D1.

For the TLC command group 412, it may be grouped into a TLC_D0 command group 423 and a TLC_D1 command group 424. For example: the TLC_D0 command group 423 includes read commands RC1(4) and RC1(5), and the physical addresses of these read commands all correspond to the chip D0. The TLC_D1 command group 424 includes the read command RC1(6), and the physical address of this read command corresponds to the chip D1.

The third step (indicated by arrow A43) is to compile commands pointing to different planes within each chip command group into the same read command group:

In the SLC_D0 command group 421, the read commands RC1(1) and RC1(8) respectively point to the plane P1 and the plane P0, so they can be compiled into one read command group. It is worth mentioning that, according to the order of the planes P0 and P1, the processing order of the read command RC1(8) (used for processing the generation of the corresponding AIPR sequence) may be set to have priority over the read command RC1(1).

In the SLC_D1 command group 422, the read commands RC1(2) and RC1(3) respectively point to the plane P0 and the plane P1, and can be compiled into one read command group; the remaining read command RC1(7) forms a group by itself.

In the TLC_D0 command group 423, the read commands RC1(4) and RC1(5) respectively point to the plane P1 and the plane P0, and can be compiled into one read command group. It is worth mentioning that, according to the order of the planes P0 and P1, the processing order of the read command RC1(5) may be set to have priority over the read command RC1(4).

In the TLC_D1 command group 424, the remaining read command RC1(6) forms a group by itself.

Finally, these read command groups form a result pool RP1 (for example, a cache area in the buffer memory 214 may be allocated as the result pool RP1), which contains the command groups sorted and optimized according to memory cell type, chip, and plane. For example, {“8”, “1”} represents a read command group containing two read commands with sequence numbers 8 and 1, which respectively correspond to different planes but belong to the same chip and memory cell type.

It should be noted that {“8”, “1”} also indicates that the processing order of the read command “8” may have priority over the read command “1”.

In addition, in another embodiment, the first grouping step and the second grouping step described above may also be interchanged.

Returning to FIG. 2, in step S230, the processor 211 generates an AIPR command sequence corresponding to the first cache pool according to the plurality of read command groups of the first cache pool.

Specifically, in an embodiment, a step of generating the AIPR command sequence includes: performing a command sequence generation operation on each read command group in sequence according to a compilation order of the plurality of read command groups, wherein when performing the command sequence generation operation on a current read command group among the plurality of read command groups, generating the AIPR command, the polling command, and the DMA command corresponding to each current second read command according to a processing order of one or more current second read commands of the current read command group to obtain a first command sequence corresponding to the current read command group; and storing the generated first command sequence into the AIPR command sequence. The generation of the command sequence for each read command group may also be referred to as the command conversion of that read command group.

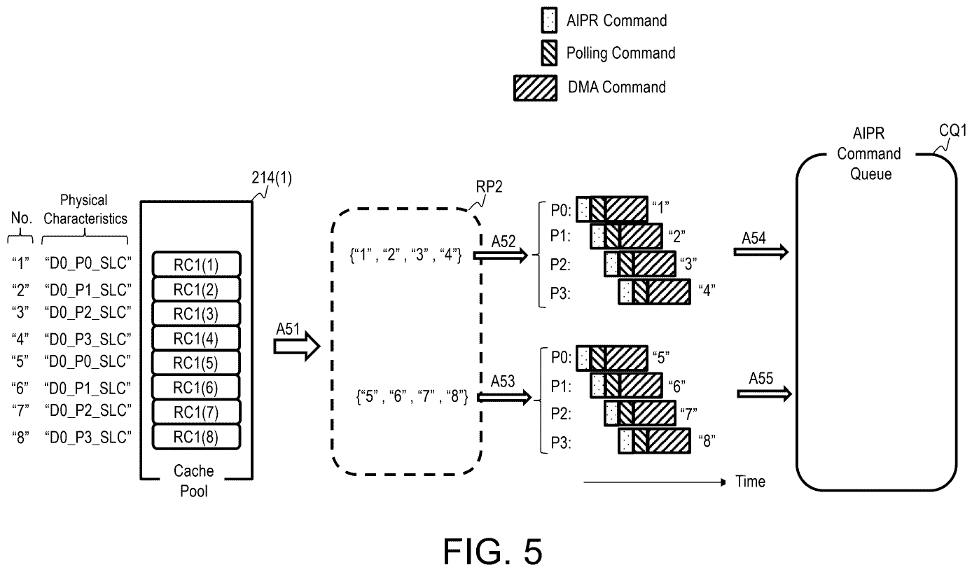

FIG. 5 is a schematic diagram of a command conversion according to an embodiment of the present disclosure. The process of command conversion is described in detail below with reference to FIG. 5. Referring to FIG. 5, the cache pool 214(1) contains 8 read commands, RC1(1) to RC1(8), and each command has a sequence number and corresponding physical characteristics. The physical characteristics include a chip number (all are D0 in this example for ease of explanation), a plane number (P0, P1, P2, or P3), and a memory cell type (all are SLC in this example for ease of explanation).

As indicated by arrow A51, after the pre-sorting operation, these 8 read commands are divided into two read command groups, forming a result pool RP2: a first group: {“1”, “2”, “3”, “4”}, which includes read commands (these grouped read commands are also referred to as second read commands) “1” through “4”; and a second group: {“5”, “6”, “7”, “8”}, which includes read commands “5” through “8”.

Next, the processor 211 performs a command sequence generation operation on these two read command groups respectively.

As indicated by arrow A52, for the first read command group (also referred to as the current read command group), a command sequence is generated, including: generating an AIPR command for the read command (also referred to as the current second read command) RC1(1), as well as a polling command and a DMA command corresponding to the AIPR command, for the plane P0; generating an AIPR command for the read command RC1(2), as well as a polling command and a DMA command corresponding to the AIPR command, for the plane P1; generating an AIPR command for the read command RC1(3), as well as a polling command and a DMA command corresponding to the AIPR command, for the plane P2; and generating an AIPR command for the read command RC1(4), as well as a polling command and a DMA command corresponding to the AIPR command, for the plane P3.

As indicated by arrow A53, for the second read command group (i.e., the next current read command group), a command sequence is generated, including: generating an AIPR command for the read command RC1(5), as well as a polling command and a DMA command corresponding to the AIPR command, for the plane P0; generating an AIPR command for the read command RC1(6), as well as a polling command and a DMA command corresponding to the AIPR command, for the plane P1; generating an AIPR command for the read command RC1(7), as well as a polling command and a DMA command corresponding to the AIPR command, for the plane P2; and generating an AIPR command for the read command RC1(8), as well as a polling command and a DMA command corresponding to the AIPR command, for the plane P3.

Next, as indicated by arrows A54 and A55, the generated command sequence (including the AIPR command, the polling command, and the DMA command for each read command group) is stored in an AIPR command sequence CQ1.

In an embodiment, a step of generating the AIPR command sequence is as follows:

First, a corresponding first AIPR command is generated one by one for each current second read command (i.e., a read command of the current read command group) according to a processing order of the current second read commands. These AIPR commands are used to initiate a read operation on a specific plane.

Next, also according to the processing order of the current second read commands, a corresponding pair of a first polling command and a first DMA command is generated for each AIPR command. The polling command is used to check a completion status of the read operation, while the DMA command is used to transfer the read data to a specified memory location.

Finally, all the generated first AIPR commands, first polling commands, and first DMA commands are combined in a specific order to form a first command sequence, which is then stored in the AIPR command sequence.

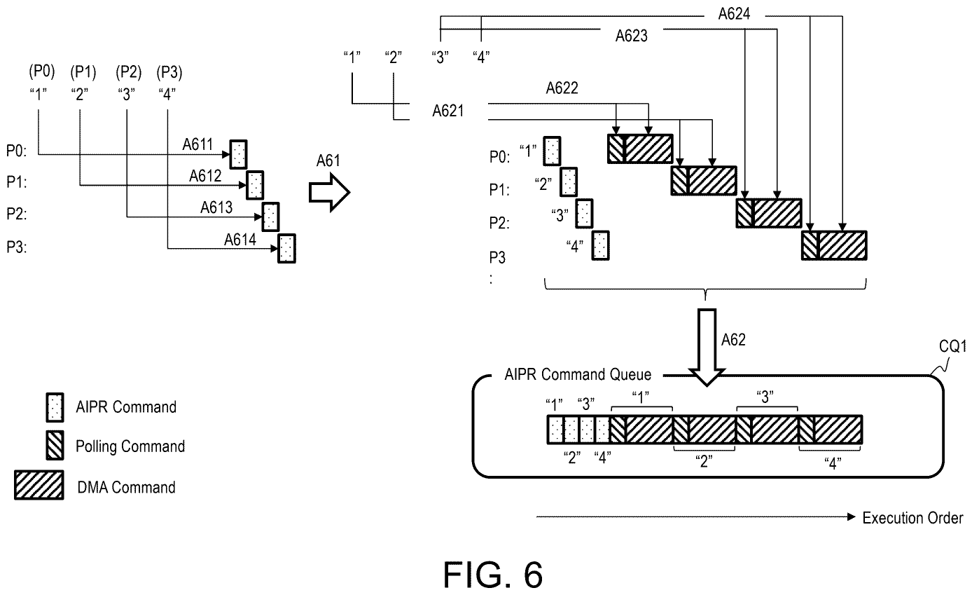

The following uses the command conversion process shown in FIG. 6 as an example to describe in detail the process of performing a command conversion on a read command group to generate and store a first command sequence.

FIG. 6 is a schematic diagram of performing a command conversion on a read command group to generate a first command sequence according to an embodiment of the present disclosure. Referring to FIG. 6, FIG. 6 shows a read command group containing 4 read commands (“1”, “2”, “3”, “4”), which respectively correspond to 4 different planes (P0, P1, P2, P3), wherein the processing order from highest priority to lowest is “1”, “2”, “3”, “4”. The command conversion process is as follows:
(1) AIPR command generation (as indicated by arrows A611-A614): an AIPR command corresponding to the plane P0 is generated for the read command “1”; an AIPR command corresponding to the plane P1 is generated for the read command “2”; an AIPR command corresponding to the plane P2 is generated for the read command “3”; and an AIPR command corresponding to the plane P3 is generated for the read command “4”.
(2) Generation of polling command and DMA command pairs: After obtaining the AIPR command for each read command corresponding to this read command group, the generation of a polling command and a DMA command pair corresponding to each AIPR command may be started (as indicated by arrow A61).

For example, as indicated by arrow A621: based on the read command “1”, a polling command and a DMA command for the AIPR command corresponding to the plane P0 are generated; as indicated by arrow A622: based on the read command “2”, a polling command and a DMA command for the AIPR command of the plane P1 are generated; as indicated by arrow A623: based on the read command “3”, a polling command and a DMA command for the AIPR command of the plane P2 are generated; as indicated by arrow A624: based on the read command “4”, a polling command and a DMA command for the AIPR command of the plane P3 are generated.
(3) Command sequence generation and storage (as indicated by arrow A62): All the previously generated commands are combined in an optimized order (in this example, the plane order) to form a first command sequence, which is then stored in an AIPR command sequence CQ1.

The processor 211 may execute the plurality of commands in this AIPR command sequence CQ1 sequentially based on their order:
First, all AIPR commands (respectively corresponding to read commands “1”, “2”, “3”, “4”) are issued in sequence to initiate parallel read operations on the four planes.

Then, the polling command and the DMA command for each plane are executed alternately, for example, the polling command and the DMA command for the plane P0; the polling command and the DMA command for the plane P1; the polling command and the DMA command for the plane P2; and the polling command and the DMA command for the plane P3.

In an embodiment, the present disclosure provides an optimized method for storing a newly generated first command sequence into an AIPR command sequence. This method considers the relationship between the current read command group and a previously existing read command group to achieve more efficient command execution. The specific steps are as follows:

First, the processor 211 checks whether there is a previous read command group sorted before the current read command group. This step ensures the continuity and correctness of the command sequence.

If the previous read command group exists, the processor 211 performs the following operations:
(1) Obtain a second command sequence of the previous read command group. This sequence includes a second AIPR command, a second polling command, and a second DMA command corresponding to the previous read command group.
(2) According to a processing order of each current second read command of the current read command group, the processor 211 inserts the newly generated first AIPR command into the previous command sequence. Specifically, each first AIPR command is inserted after the second DMA command corresponding to the same plane. This insertion method ensures that a new AIPR read operation (also referred to as a parallel read operation) for the same plane can start immediately after the data transfer of the previous AIPR read operation is completed.
(3) Finally, the processor 211 sequentially stores the newly generated pairs of the first polling command and the first DMA command into the AIPR command sequence according to the processing order of the current second read commands.

This method not only ensures the continuity of command execution, but also maximizes the parallel operation capability of the flash memory chip by optimizing the command insertion positions.

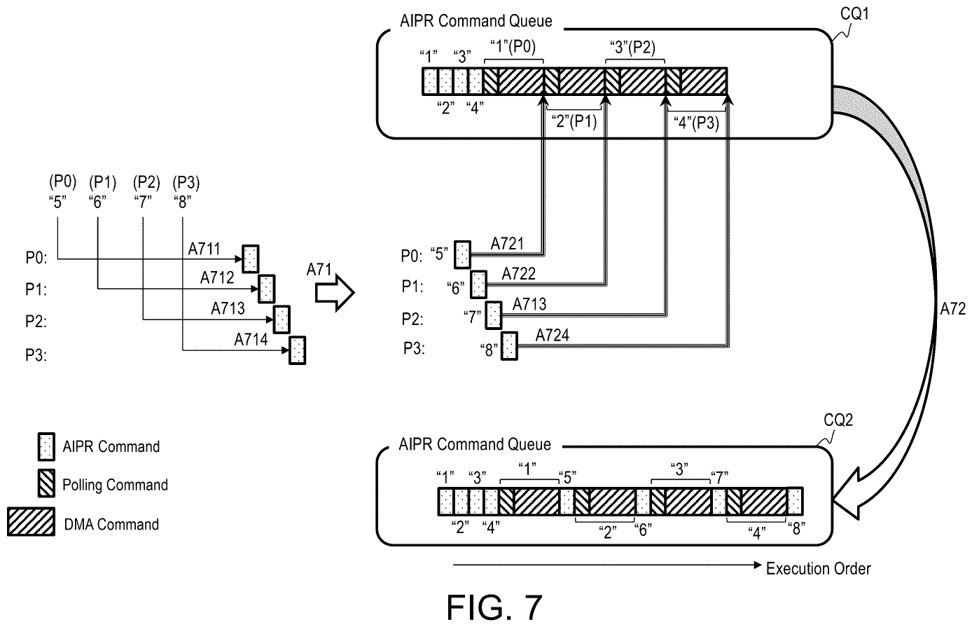

The following uses FIG. 7 to describe this process in detail. FIG. 7 is a schematic diagram of inserting an AIPR command of a read command group into a command sequence of a previous read command group according to an embodiment of the present disclosure. Referring to FIG. 7, FIG. 7 shows how to insert a newly generated command sequence when a command sequence of a previous read command group (CQ1) already exists in the AIPR command sequence.
(1) Initial state: The AIPR command sequence CQ1 already includes the command sequence of the previous read command group, including AIPR commands (also referred to as second AIPR commands) respectively corresponding to read commands “1”, “2”, “3”, “4”, and 4 corresponding pairs of polling commands (also referred to as second polling commands) and DMA commands (also referred to as second DMA commands).
(2) Generate AIPR commands for the new command sequence: As indicated by arrows A711-A714, new AIPR commands (also referred to as first AIPR commands) are generated for the current read command group {“5”, “6”, “7”, “8”}, respectively corresponding to read commands “5”, “6”, “7”, “8”.
(3) AIPR command insertion (as indicated by arrow A71):

As indicated by arrow A721: the AIPR command corresponding to the read command “5” is inserted after the DMA command of the read command “1” which corresponds to the same plane (P0).

As indicated by arrow A72: the AIPR command corresponding to the read command “6” is inserted after the DMA command of the read command “2” which corresponds to the same plane (P1).

As indicated by arrow A73: the AIPR command corresponding to the read command “7” is inserted after the DMA command of the read command “3” which corresponds to the same plane (P2).

As indicated by arrow A74: the AIPR command corresponding to the read command “8” is inserted after the DMA command of the read command “4” which corresponds to the same plane (P3).

Next, as indicated by arrow A72, according to the steps described above, after determining whether the planes are the same in order to insert the AIPR commands of the read commands “5”, “6”, “7”, “8” of the current read command group {“5”, “6”, “7”, “8”} into the AIPR command sequence CQ1, an AIPR command sequence CQ2 is obtained.

After inserting the AIPR commands of the read commands “5”, “6”, “7”, “8” of the current read command group {“5”, “6”, “7”, “8”} into the AIPR command sequence CQ1, it is also necessary to generate and store a pair of a polling command (also referred to as a first polling command) and a DMA command (also referred to as a first DMA command) for each of the AIPR commands corresponding to the read commands “5”, “6”, “7”, “8”, to complete the operation of generating and storing the command sequence corresponding to the current read command group {“5”, “6”, “7”, “8”}.

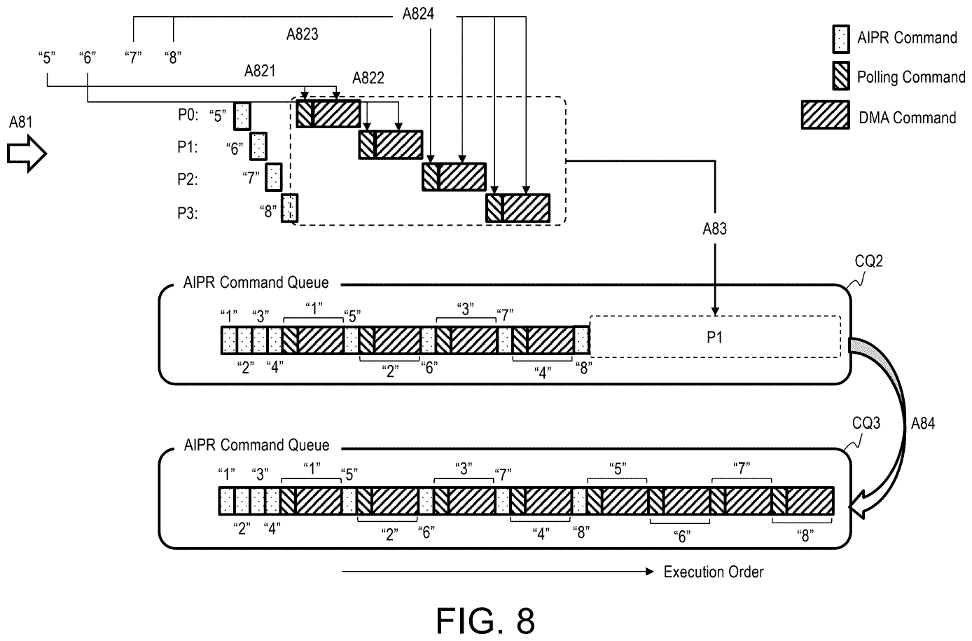

Hereinafter, continuing with the example of FIG. 7, this process is described in detail in conjunction with FIG. 8. FIG. 8 is a schematic diagram of storing a polling command and a DMA command of a read command group into an AIPR command sequence according to an embodiment of the present disclosure. Referring to FIG. 8, FIG. 8 shows how to generate and store the corresponding polling command and DMA command after inserting the AIPR commands of the current read command group {“5”, “6”, “7”, “8”} into the AIPR command sequence CQ1.

It is assumed that the AIPR commands respectively corresponding to the read commands “5”, “6”, “7”, “8” have been inserted after the DMA commands of the corresponding planes, forming an intermediate AIPR command sequence CQ2.
(1) Generate polling command and DMA command corresponding to the AIPR commands (as indicated by arrow A81):
As indicated by arrow A821: a corresponding pair of a polling command and a DMA command is generated for the read command “5”; as indicated by arrow A822: a corresponding pair of a polling command and a DMA command is generated for the read command “6”; as indicated by arrow A823: a corresponding pair of a polling command and a DMA command is generated for the read command “7”; as indicated by arrow A824: a corresponding pair of a polling command and a DMA command is generated for the read command “8”.
(2) Storage of polling command and DMA command (as indicated by arrow A83): The pairs of the polling command and the DMA command generated in steps A821-A824 are sequentially stored at the end of the AIPR command sequence CQ2 (as shown in block P1) according to the processing order of “5”, “6”, “7”, “8”.
(3) Final AIPR command sequence formation (as indicated by arrow step A84): After storing these pairs of the polling command and the DMA command, a final AIPR command sequence CQ3 is obtained.

The above embodiment has described the generation and storage of a command sequence corresponding to the current read command group into the AIPR command sequence in a case where the AIPR command sequence has a command sequence of a previous read command group. In the AIPR command sequence CQ3: the AIPR commands “5”, “6”, “7”, “8” are inserted after the previous DMA command of the corresponding plane, and the newly generated pairs of the polling command and the DMA command are arranged in order at the end of the sequence (P1).

Returning to FIG. 2, in step S240, the processor 211 executes the plurality of commands according to the generated AIPR command sequence to complete an AIPR read operation corresponding to the plurality of first read commands.

Based on the pre-sorted command groups, the processor 211 generates an AIPR command sequence. This sequence includes AIPR commands, polling commands, and Direct Memory Access (DMA) commands, which are generated and stored in the AIPR command sequence according to the method to achieve optimal parallel read performance.

Finally, the memory interface control circuit 213 executes corresponding commands according to the generated AIPR command sequence to complete the AIPR read operation on the rewritable non-volatile memory module 220. This method significantly improves the efficiency of data reading, especially in scenarios with a large number of random read requests.

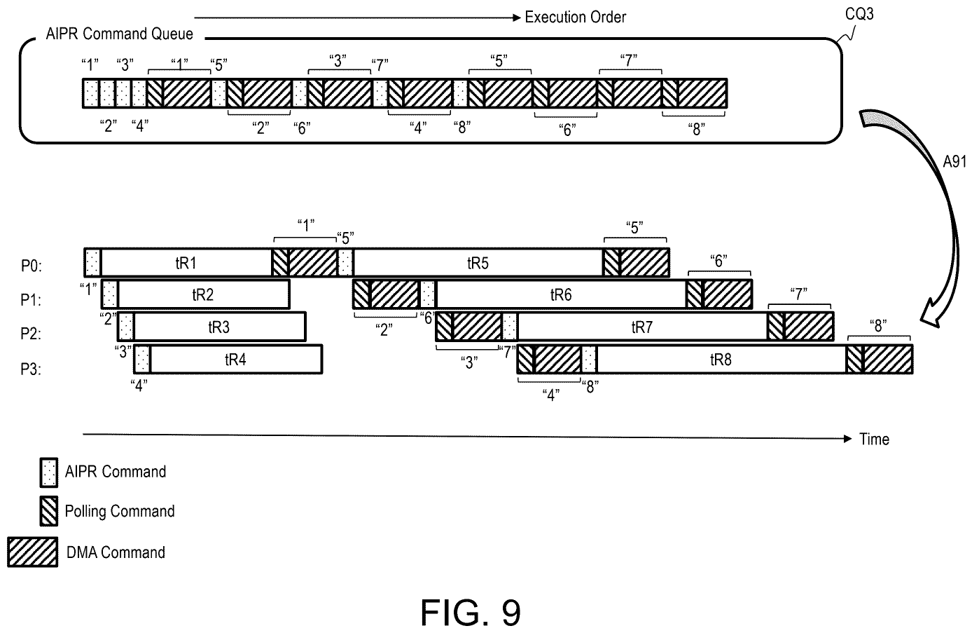

FIG. 9 is a command execution timing diagram of an AIPR command sequence according to an embodiment of the present disclosure. Referring to FIG. 9, in an embodiment, a situation where the AIPR command sequence CQ3 is actually executed is as follows:
(1) AIPR command execution: First, the system (the processor 211) simultaneously sends AIPR commands corresponding to read commands “1”, “2”, “3”, “4” to four planes (P0, P1, P2, P3) to initiate a parallel read operation.
(2) Data preparation time: After each AIPR command, there is a corresponding data preparation time (tR1, tR2, tR3, tR4). During this period, each plane independently performs a data read operation.
(3) Interleaved execution of polling and DMA commands: When the data preparation time tR1 for the read command “1” corresponding to the plane P0 ends, the system executes the polling command and the DMA command for the read command “1”.

After executing the DMA command on the plane P0, the system sends the AIPR command for the read command “5” to the plane P0 to start the next round of reading for the plane P0 (entering the data preparation time tR5 for the AIPR command of the read command “5”).

During the data preparation time tR5 of the AIPR command for the read command “5”, an operation for the next plane P1 may be executed. More specifically, because the data preparation time tR2 for the read command “2” of the next plane P1 has already ended, the polling command and the DMA command for the read command “2” may be executed.

After executing the DMA command on the plane P1, the system sends the AIPR command for the read command “6” to the plane P1 to start the next round of reading for the plane P1 (entering the data preparation time tR6 for the AIPR command of the read command “6”).

During the data preparation time tR6 of the AIPR command for the read command “6”, the system continues to execute an operation for the next plane P2. More specifically, because the data preparation time tR3 for the read command “3” of the plane P2 has already ended, the system executes the polling command and the DMA command for the read command “3”.

After executing the DMA command on the plane P2, the system sends the AIPR command for the read command “7” to the plane P2 to start the next round of reading for the plane P2 (entering the data preparation time tR7 for the AIPR command of the read command “7”).

During the data preparation time tR7 of the AIPR command for the read command “7”, the system turns to process an operation for the last plane P3. Since the data preparation time tR4 for the read command “4” of the plane P3 has already ended, the system executes the polling command and the DMA command for the read command “4”.

After executing the DMA command on the plane P3, the system sends the AIPR command for the read command “8” to the plane P3 to start the next round of reading for the plane P3 (entering the data preparation time tR8 for the AIPR command of the read command “8”).

At this point, the system has completed the first round of read operations for all four planes and has already initiated the second round of reading. Next, the system returns to the plane P0 to check whether the data for the read command “5” is ready. If the data preparation time tR5 has ended, the polling command and the DMA command for the read command “5” are executed. By analogy, after the corresponding data preparation times tR6-tR8 end, the corresponding polling commands and DMA commands for the read commands “6” through “8” are executed.

This cyclical process continues until all the read commands have been executed. Through this highly optimized interleaved execution method, the utilization of the read operations on each plane of the flash memory is maximized, significantly improving the parallelism and efficiency of data reading.

In an embodiment, the present disclosure provides another method for generating an AIPR command sequence. This method performs a command conversion on each second read command within each group according to a compilation order of the read command groups. The command conversion process considers not only the current read command group but also the next read command group. The specific steps are as follows:
(1) Generate an AIPR command for each second read command (also referred to as a current second read command) that has not yet been converted in the current read command group.
(2) Generate a corresponding polling command and a DMA command for each AIPR command.
(3) For each AIPR command, check its corresponding plane and see if there is a target read command pointing to the same plane in the next read command group.
(4) If a target read command pointing to the same plane exists, generate a corresponding target AIPR command, insert it after the DMA command corresponding to the current AIPR command (the AIPR command for the same plane), and generate a target polling command and a target DMA command.
(5) If a target read command pointing to the same plane does not exist, complete the command conversion for all commands in the current read command group, and set the next read command group as a new current read command group.

It should be noted that if there is no next read command group, the generation of the entire AIPR command sequence for this cache pool is completed.

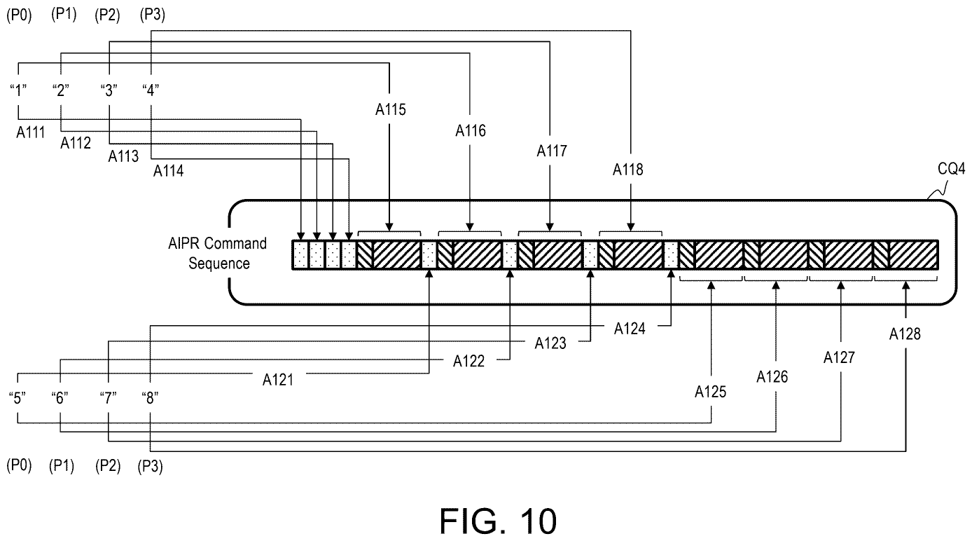

The following uses FIG. 10 to describe this process in detail. FIG. 10 is a schematic diagram of generating a corresponding AIPR command sequence according to a plurality of read command groups according to an embodiment of the present disclosure.

Referring to FIG. 10, FIG. 10 shows how two read command groups ({“1”, “2”, “3”, “4”} and {“5”, “6”, “7”, “8”}) generate a corresponding AIPR command sequence CQ4.
(1) Process the first read command group: As indicated by arrows A111-A114, AIPR commands are generated for read commands “1”, “2”, “3”, “4” and stored in the AIPR command sequence. Since there is no command sequence of any read command group within the AIPR command sequence, the generated AIPR commands may be stored directly (without considering any previous read command group). As indicated by arrows A115-A118, corresponding polling commands and DMA commands are generated for these AIPR commands.
(2) Process the second read command group and interleave with the first read command group: As indicated by arrow A121, it is checked that the read command “5” corresponds to the plane P0, which is the same as the read command “1”, therefore, an AIPR command corresponding to the read command “5” is generated and inserted after the DMA command of the read command “1”.

By analogy, as indicated by arrows A122-A124, the AIPR commands for read commands “6”, “7”, “8” are respectively inserted after the DMA commands of read commands “2”, “3”, “4” that correspond to the same plane.

The polling commands and DMA commands generated above corresponding to read commands “1”, “2”, “3”, “4” and the AIPR commands corresponding to read commands “5”, “6”, “7”, “8” are all stored in the AIPR command sequence CQ4.

As indicated by arrows A125-A128, finally, corresponding polling commands and DMA commands are generated for read commands “5”, “6”, “7”, “8” and inserted in order at the end of the sequence.

In another embodiment, performing the command sequence generation operation on the plurality of read command groups includes: performing a command conversion on each second read command of each read command group according to the compilation order of the plurality of read command groups, wherein the command conversion includes generating an AIPR command, a polling command, and a DMA command according to a corresponding second read command.

Wherein, for the current read command group on which the command conversion is being performed:
performing the command conversion on each current second read command of the current read command group on which the command conversion has not yet been performed, including the following steps:
if an AIPR command of a current second read command on which the command conversion is being performed has not yet been generated, generating an AIPR command corresponding to the current second read command, and generating a corresponding polling command and a DMA command for the AIPR command;
if the AIPR command of the current second read command on which the command conversion is being performed has already been generated, generating a corresponding polling command and a DMA command for the AIPR command;
after generating the corresponding polling command and the DMA command, obtaining the plane corresponding to the AIPR command, and checking whether there is a target read command pointing to a same plane in a next read command group;
wherein if the target read command pointing to the same plane exists, generating a corresponding target AIPR command based on the target read command of the next read command group, inserting the target AIPR command after the DMA command corresponding to the AIPR command, and completing the command conversion of the current second read command; and
wherein if the target read command pointing to the same plane does not exist, completing the command conversion of the current second read command, and repeating the above steps to perform the command conversion on a next current read command.

The following uses FIG. 10 to illustrate this concept. According to the arrows A111-A128 shown in FIG. 10, we can describe the generation and storage order of each command sequentially as follows:
As indicated by arrow A111, an AIPR command corresponding to the read command “1” is generated and stored in the AIPR command sequence CQ4;
As indicated by arrow A112, an AIPR command corresponding to the read command “2” is generated and stored in the AIPR command sequence CQ4;
As indicated by arrow A113, an AIPR command corresponding to the read command “3” is generated and stored in the AIPR command sequence CQ4;
As indicated by arrow A114, an AIPR command corresponding to the read command “4” is generated and stored in the AIPR command sequence CQ4;
As indicated by arrow A115, a polling command and a DMA command corresponding to the read command “1” are generated and stored in the AIPR command sequence CQ4, completing the command conversion for the read command “1”;
As indicated by arrow A121, after completing the command conversion for the read command “1”, it is checked that the read command “5” of the next read command group points to the same plane P0, an AIPR command corresponding to the read command “5” is generated and inserted after the DMA command corresponding to the read command “1”;
As indicated by arrow A116, a polling command and a DMA command corresponding to the read command “2” are generated and stored in the AIPR command sequence CQ4, completing the command conversion for the read command “2”;
As indicated by arrow A122, after completing the command conversion for the read command “2”, it is checked that the read command “6” of the next read command group points to the same plane P1, an AIPR command corresponding to the read command “6” is generated and inserted after the DMA command corresponding to the read command “2”;
As indicated by arrow A117, a polling command and a DMA command corresponding to the read command “3” are generated and stored in the AIPR command sequence CQ4, completing the command conversion for the read command “3”;
As indicated by arrow A123, after completing the command conversion for the read command “3”, it is checked that the read command “7” of the next read command group points to the same plane P2, an AIPR command corresponding to the read command “7” is generated and inserted after the DMA command corresponding to the read command “3”;
As indicated by arrow A118, a polling command and a DMA command corresponding to the read command “4” are generated and stored in the AIPR command sequence CQ4, completing the command conversion for the read command “4”;
As indicated by arrow A124, after completing the command conversion for the read command “4”, it is checked that the read command “8” of the next read command group points to the same plane P3, an AIPR command corresponding to the read command “8” is generated and inserted after the DMA command corresponding to the read command “4”;
As indicated by arrow A125, a polling command and a DMA command corresponding to the read command “5” are generated and stored at the end of the AIPR command sequence CQ4, completing the command conversion for the read command “5”, and after completing the command conversion for the read command “5”, it is checked that there is no read command in a next read command group pointing to the same plane P0, and it is determined that the next read command “6” can be processed;
As indicated by arrow A126, a polling command and a DMA command corresponding to the read command “6” are generated and stored at the end of the AIPR command sequence CQ4, completing the command conversion for the read command “6”, and after completing the command conversion for the read command “6”, it is checked that there is no read command in a next read command group pointing to the same plane P1, and it is determined that the next read command “7” can be processed;
As indicated by arrow A127, a polling command and a DMA command corresponding to the read command “7” are generated and stored at the end of the AIPR command sequence CQ4, completing the command conversion for the read command “7”, and after completing the command conversion for the read command “7”, it is checked that there is no read command in a next read command group pointing to the same plane P2, and it is determined that the next read command “8” can be processed;

As indicated by arrow A128, a polling command and a DMA command corresponding to the read command “8” are generated and stored at the end of the AIPR command sequence CQ4, completing the command conversion for the read command “8”.

The command generation and storage order in this other embodiment ensures the efficient execution of AIPR commands, while maximizing the potential of parallel read operations. By inserting the AIPR commands of the second group of read commands after the DMA commands of the first group of commands, the system is able to start the next read operation immediately after completing the data transfer of the previous read operation, so as to significantly improve the read efficiency of the flash memory.

Based on the plurality of embodiments described above, the generation method of the AIPR command sequence of the present disclosure has a plurality of advantages:
(1) Maximizing parallel execution: By inserting the AIPR commands of the next group in advance, the system can start a new read operation immediately after the data transfer of the previous read operation is completed.
(2) Reducing latency: This method minimizes the idle time between planes, ensuring that each plane can work continuously.
(3) Dynamic adjustment: The method is able to dynamically adjust the command sequence according to actual situations to adapt to different read modes and workloads.
(4) Proactive optimization: By considering the situation of the next read command group, a more long-term optimization strategy is achieved.

In yet another embodiment, the present disclosure also provides a method for dynamically optimizing the generation of an AIPR command sequence. This method proactively considers the next read command group when processing the current read command group, and adjusts the processing order of a plurality of commands in the next read command group according to the working state of the planes. The specific steps are as follows:
(1) Check the next read command group: When performing the command sequence generation operation on the current read command group, the system checks the next read command group sorted after it. The purpose of this step is to obtain the plane pointed to by each second read command in the next group and its working state.
(2) Determine the working state of the plane: The system determines the working state of the plane through the following rules:
(a) If a plane (referred to as a first plane) pointed to by a certain second read command in the next read command group is not pointed to by any command in the current read command group, then the first plane is determined to be in an idle state.
(b) If a plane (referred to as a second plane) pointed to by a certain second read command in the next read command group has already been pointed to by a command in the current read command group, then the second plane is determined to be in a busy state.
(3) Adjust the command processing order: Based on the above determination results, the system adjusts the processing order of the commands in the next read command group. Specifically, the system prioritizes the processing of those read commands corresponding to planes in the idle state.

For example, assume that the current read command group includes commands pointing to planes P0 and P1, and the next read command group includes commands pointing to planes P0, P1, P2, and P3.
(1) The system first processes the commands of the current read command group.
(2) When generating the AIPR command sequence for the current read command group, the system checks the commands of the next read command group: planes P0 and P1 are determined to be in a busy state (because they are used by the current read command group), and planes P2 and P3 are determined to be in an idle state.
(3) The system adjusts the processing order of the next read command group: Original order: P0, P1, P2, P3. Adjusted order: P2, P3, P0, P1. In this way, the commands pointing to the idle planes P2 and P3 are processed in advance.
(4) When generating the AIPR command sequence, the system will: after generating and storing the AIPR commands for the planes P0 and P1 corresponding to the current read command group, generate and store the AIPR commands for the planes P2 and P3 corresponding to the next read command group. Immediately after the polling command and the DMA command for the read command corresponding to the plane P0 in the current read command group are stored, the AIPR command for the plane P0 corresponding to the next read command group is inserted. Immediately after the polling command and the DMA command for the command corresponding to the plane P1 in the current read command group are stored, the AIPR command for the plane P1 corresponding to the next read command group is inserted. Since all read commands of the current read command group have completed command conversion, the generation and storage of the next polling commands and DMA commands will be processed. It should be noted that the polling commands and DMA commands for the read commands corresponding to planes P2 and P3 will be generated and stored first.

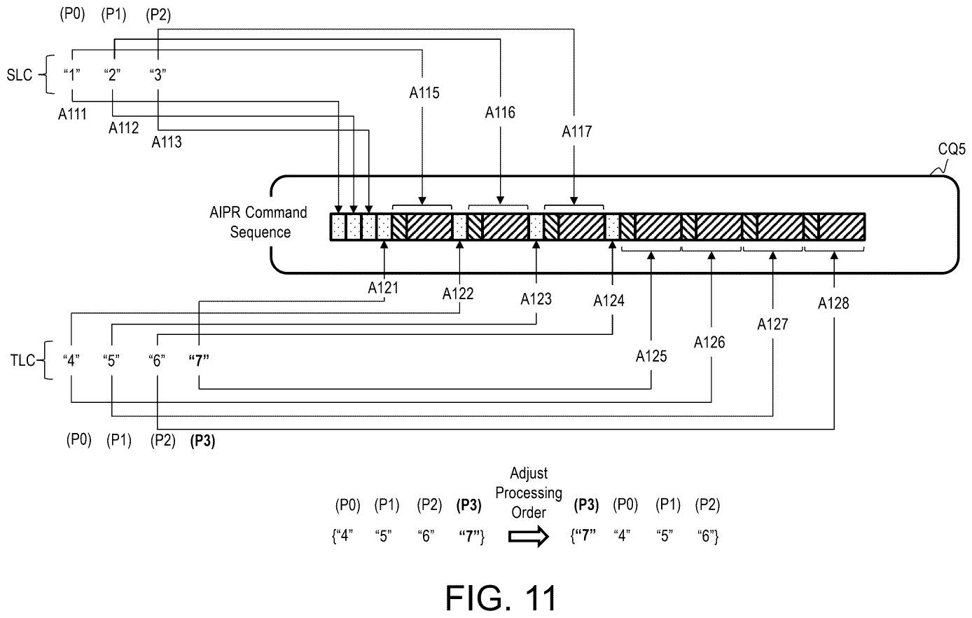

The following uses FIG. 11 for illustration. FIG. 11 is a schematic diagram of generating a corresponding AIPR command sequence according to a plurality of read command groups according to another embodiment of the present disclosure.

Referring to FIG. 11, two read command groups are used as an example for description.

The first read command group includes three SLC-type commands {“1”, “2”, “3”}, respectively corresponding to planes P0, P1, and P2. The second read command group includes four TLC-type commands {“4”, “5”, “6”, “7”}, respectively corresponding to planes P0, P1, P2, and P3. The process is as follows:
(1) Process the first read command group: As indicated by arrows A111, A112, and A113, the system first generates and stores the AIPR commands for read commands “1”, “2”, and “3”.
(2) Check the second read command group: When processing the first read command group, the system checks the planes pointed to by each command in the second read command group and their working states:
The planes P0, P1, and P2 pointed to by read commands “4”, “5”, and “6” are determined to be in a busy state because they have been used by read commands “1”, “2”, and “3” of the first read command group.

The plane P3 pointed to by the read command “7” is determined to be in an idle state because the first read command group did not use the plane P3.
(3) Adjust the processing order of the second group of commands: Based on the above determination, the system adjusts the processing order of the second read command group from the original {“4”, “5”, “6”, “7”} to {“7”, “4”, “5”, “6”}, prioritizing the processing of the read command “7” which points to the idle plane P3.
(4) Generate the optimized AIPR command sequence: As indicated by arrow A121, the processor 211 first generates and inserts the AIPR command for the read command “7”, immediately following the AIPR commands of the first read command group.

Next, as indicated by arrows A115, A116, and A117, the processor 211 then generates and stores the corresponding polling commands and DMA commands for read commands “1”, “2”, and “3”. At this point, the command conversion and command sequence storage for the first read command group have been completed.

Meanwhile, as indicated by arrows A122, A123, and A124, the processor 211 then generates and inserts the AIPR commands for read commands “4”, “5”, and “6” after the DMA commands corresponding to read commands “1”, “2”, and “3”.

As indicated by arrows A125, A126, A127, and A128, the processor 211 finally generates and stores the polling commands and DMA commands for read commands “7”, “4”, “5”, and “6”. At this point, the command conversion and command sequence storage for the second read command group have been completed.

Finally, an AIPR command sequence CQ5 is obtained.

This method brings the following advantages:
(1) Improving parallelism: By prioritizing the processing of commands for idle planes, the parallel operation capability of the flash memory is maximized.
(2) Reducing waiting time: An idle plane can immediately start a new read operation without needing to wait for all commands in the current group to complete.
(3) Dynamic optimization: The command order is adjusted according to the real-time state of the planes, making it more adaptive.
(4) Improving overall efficiency: Through intelligent scheduling, the idle time of the planes is reduced, and the overall throughput of the storage system is improved.

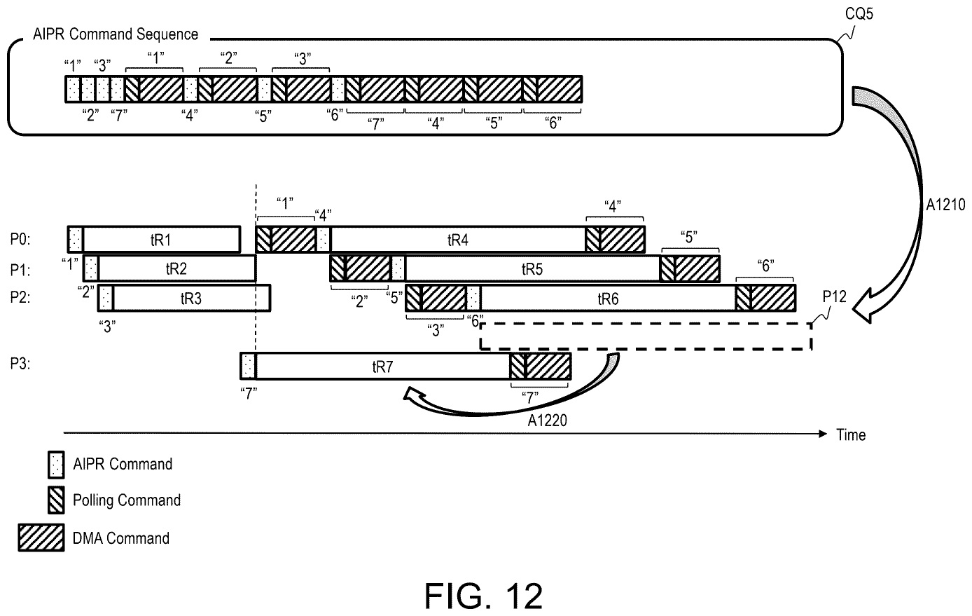

FIG. 12 is a command execution timing diagram of an AIPR command sequence according to another embodiment of the present disclosure. Referring to FIG. 12, continuing with the example of FIG. 11, as indicated by arrow A1210, an execution status of the AIPR command sequence CQ5 may be as follows:
(1) AIPR command execution: First, the system simultaneously sends AIPR commands corresponding to the SLC-type read commands “1”, “2”, “3” to three planes (P0, P1, P2) to initiate a parallel read operation.
(2) Data preparation time: After each AIPR command, there is a corresponding data preparation time (tR1, tR2, tR3). During this period, each plane independently performs an SLC-type data read operation.
(3) Check the next read command group: The processor 211 determines that the read command “7” within the next read command group corresponds to the idle plane P3. The processor 211 generates and inserts the AIPR command for the read command “7” (the processing order of the read command “7” has been advanced, because the processing order of the second read command group before adjustment was “4”, “5”, “6”, “7”).
(4) Interleaved execution of polling and DMA commands of the current read command group: When the data preparation time tR1 for the read command “1” corresponding to the plane P0 ends, the system executes the polling command and the DMA command for the read command “1”. It should be noted that this step is executed after the AIPR command for the read command “7” is inserted.

After executing the DMA command for the read command “1” on the plane P0, the processor 211 checks that the next read command group has the read command “4” for the same plane P0, sends the AIPR command for the read command “4” of the next read command group to the plane P0, and starts the next round of reading for the plane P0 (entering the data preparation time tR4 for the AIPR command of the read command “4”).

During the data preparation time tR4 of the AIPR command for the read command “4”, the system executes an operation for the plane P1. Since the data preparation time tR2 for the read command “2” of the plane P1 has already ended, the system executes the polling command and the DMA command for the read command “2”.

After executing the DMA command for the read command “2” on the plane P1, the system sends the AIPR command for the read command “5” to the plane P1 to start the next round of reading for the plane P1 (entering the data preparation time tR5 for the AIPR command of the read command “5”).

During the data preparation time tR5 of the AIPR command for the read command “5”, the system continues to execute an operation for the plane P2. Since the data preparation time tR3 for the read command “3” of the plane P2 has already ended, the system executes the polling command and the DMA command for the read command “3”.

After executing the DMA command for the read command “3” on the plane P2, the system sends the AIPR command for the read command “6” to the plane P2 to start the next round of reading for the plane P2 (entering the data preparation time tR6 for the AIPR command of the read command “6”).

During the data preparation time tR6 of the AIPR command for the read command “6”, the system continues to execute an operation for the plane P3. Since the data preparation time tR7 for the read command “7” of the plane P3 has already ended, the system executes the polling command and the DMA command for the read command “7”.

Next, as the data preparation times tR4-tR6 corresponding to the read commands “4” through “6” end, the system executes the corresponding polling commands and DMA commands for the read commands “4” through “6”, completing the execution of the entire AIPR command sequence CQ5.

It is worth noting that, as indicated by arrow A1220, the AIPR command, the polling command, and the DMA command corresponding to the read command “7” are executed in advance as a whole. This is because the system detects that the plane P3 is in an idle state, and therefore prioritizes the processing of the read command “7” which points to P3.

Through this highly optimized execution method for the AIPR command sequence, the present disclosure significantly improves the read efficiency of the flash memory, especially in complex scenarios involving mixed memory cell types and different plane states. This method not only maximizes the advantages of parallel reading, but also ensures the optimal utilization of system resources through intelligent scheduling.

It should be noted that, in this embodiment, the SLC read command group is processed first because its overall processing time is faster.

In an embodiment, the present disclosure provides a method for further optimizing the generation of an AIPR command sequence. The method reduces command transmission overhead and improves overall read efficiency by identifying consecutive read operations and merging a plurality of AIPR commands. The specific steps are as follows:
(1) Identify consecutive read operations: When generating a target command sequence, the system analyzes the physical addresses of the read commands. If it is found that a plurality of read commands point to consecutive pages of the same plane, these commands are identified as a consecutive read operation.
(2) Merge AIPR commands: For the identified consecutive read operation, the system no longer generates a separate AIPR command for each read command, but instead merges them into a multi-page AIPR command.
(3) Generate multi-page AIPR command: The multi-page AIPR command includes a starting address and a page count of the consecutive pages, enabling a flash memory controller to initiate read operations for a plurality of pages at once.
(4) Adjust polling and DMA commands: Correspondingly, the system adjusts subsequent polling commands and DMA commands to adapt to the multi-page read operation.

This method brings the following advantages:
(1) Reducing command transmission overhead: By merging a plurality of AIPR commands into one, the number of command transmissions is significantly reduced, lowering bus occupancy and processor load.
(2) Improving read efficiency: The flash memory controller can initiate the reading of a plurality of pages at once, reducing the latency between each individual page read.
(3) Simplifying the command sequence: The merged command sequence is more concise and easier to manage and execute.

Finally, this embodiment also provides a computer program product, including computer-readable code, or a non-volatile computer-readable storage medium carrying computer-readable code. When the computer-readable code is run in a processor of the host system, the processor executes the steps of the above-mentioned data reading method and memory controller. The computer program product may be specifically implemented by hardware, firmware, software, or a combination thereof. In an optional embodiment, the computer program product is specifically embodied as a computer storage medium, and in another optional embodiment, the computer program product is specifically embodied as a software product, such as a Software Development Kit (SDK), etc.

Based on the foregoing, the data reading method and the memory controller provided by the embodiments of the present disclosure may achieve the following effects:
(1) Improvement in parallel read efficiency: The present disclosure, by optimizing the generation and execution of the AIPR command sequence, fully utilizes the multi-plane structure of the flash memory, significantly improving parallel read efficiency. By simultaneously sending AIPR commands to a plurality of planes, the system is able to initiate a plurality of read operations at the same time, greatly increasing data access speed.
(2) Dynamic scheduling optimization: The present disclosure introduces a dynamic scheduling mechanism that is able to adjust the processing order of read commands according to the real-time working state of the planes. By prioritizing the processing of commands pointing to idle planes, the system reduces the idle time of the planes and improves resource utilization, so as to further enhance the overall read performance.
(3) Support for mixed memory cell types: The present disclosure is able to simultaneously process read commands for different types of memory cells (such as SLC and TLC). By considering the characteristics of different memory cell types, the system can optimize the command execution order in a targeted manner, performing excellently when handling complex mixed storage structures.
(4) Latency minimization: By interleaving the execution of AIPR commands, polling commands, and DMA commands, the present disclosure minimizes the waiting time between various operations. For example, while one plane is performing a data transfer, the system can simultaneously start read operations on other planes, effectively reducing the overall read latency.
(5) Maximization of resource utilization: The method of the present disclosure ensures the efficient utilization of each plane in the flash memory. Through intelligent scheduling and dynamic adjustment, the system is able to maximize the number of active planes at any given point in time, so as to improve the overall throughput.
(6) Adaptability and flexibility: The method of the present disclosure is able to adapt to various read modes and workloads. Whether for sequential reads or random reads, the system can dynamically adjust its strategy to obtain optimal performance. This flexibility allows the present disclosure to maintain high efficiency in various application scenarios.
(7) Command queue optimization: Through pre-sorting and dynamic adjustment, the present disclosure optimizes the structure of the AIPR command sequence. This not only improves the efficiency of command execution but also reduces the overhead of command transmission and processing.
(8) Improvement in data transfer efficiency: By optimizing the execution timing of DMA commands, the present disclosure ensures the continuity and efficiency of the data transfer process. This reduces interruptions and waiting times during data transfer, improving the overall data throughput.

It should be noted that, in the above embodiments, the target AIPR command is also referred to as the target read trigger command; the target DMA command is also referred to as the target data access command; the first AIPR command and the second AIPR command are also respectively referred to as the first read trigger command and the second read trigger command; and the first DMA command and the second DMA command are also respectively referred to as the first data access command and the second data access command.

Finally, it should be noted that the above embodiments are only for illustrating the technical solutions of the present disclosure, not for limiting it; although the present disclosure has been described in detail with reference to the foregoing embodiments, a person of ordinary skill in the art should understand that they can still make modifications to the technical solutions described in the foregoing embodiments, or make equivalent replacements to some or all of the technical features therein; and these modifications or replacements do not cause the essence of the corresponding technical solutions to depart from the scope of the technical solutions of the embodiments of the present disclosure.

What is claimed is:

1. A data reading method, adapted for a storage device configured with a rewritable non-volatile memory module, wherein the storage device supports an asynchronous independent plane read, the method comprising:
storing a plurality of read commands from a host system into one or more cache pools respectively, wherein the one or more cache pools respectively correspond to different chip enable pins, and all read commands in each cache pool point to the chip enable pin corresponding to the cache pool to which it belongs;
when a preset condition is met, performing a pre-sorting operation on a plurality of first read commands in a first cache pool among the one or more cache pools to group the plurality of first read commands into a plurality of read command groups, wherein one or more second read commands belonging to a same read command group respectively correspond to different planes of a same chip in the storage device, and memory cells corresponding to each of the one or more second read commands belong to a same memory cell type;
generating an execution command sequence corresponding to the first cache pool according to the plurality of read command groups of the first cache pool; and
executing a plurality of commands in the execution command sequence according to the execution command sequence to complete a parallel read operation corresponding to the plurality of first read commands.

2. The data reading method according to claim 1, wherein the preset condition comprises at least one of the following:
a number of the plurality of first read commands stored in the first cache pool reaches a predetermined threshold; or
a waiting time of a first read command earliest stored in the first cache pool reaches a predetermined time threshold.

3. The data reading method according to claim 1, wherein the method further comprises:
obtaining a physical address of each read command according to recorded mapping information; and
obtaining physical characteristics of the physical address of the read command according to the physical address of the read command, wherein the physical characteristics comprise the chip enable pin, the plane, a chip, and the memory cell type.

4. The data reading method according to claim 3, wherein a step of performing the pre-sorting operation comprises:
grouping the plurality of first read commands according to the memory cell type corresponding to each of the plurality of first read commands to obtain one or more memory cell type command groups, wherein one or more first read commands belonging to a same memory cell type command group correspond to a same memory cell type;
grouping the one or more first read commands within the same memory cell type command group according to the chip corresponding to each of the one or more first read commands within the same memory cell type command group to obtain one or more chip command groups, wherein one or more first read commands belonging to a same chip command group correspond to a same chip; and
compiling one or more second read commands respectively pointing to different planes within each chip command group into a same read command group to obtain the plurality of read command groups, wherein a processing order of the one or more second read commands within each read command group is set based on an order of corresponding planes.

5. The data reading method according to claim 3, wherein a plurality of commands within the execution command sequence comprise the following types: a read trigger command, a polling command, and a data access command, and wherein a step of generating the execution command sequence comprises:
performing a command sequence generation operation on each read command group in sequence according to a compilation order of the plurality of read command groups,
wherein when performing the command sequence generation operation on a current read command group among the plurality of read command groups, generating the read trigger command, the polling command, and the data access command corresponding to each current second read command according to a processing order of one or more current second read commands of the current read command group to obtain a first command sequence corresponding to the current read command group; and
storing the generated first command sequence into the execution command sequence.

6. The data reading method according to claim 5, wherein the method further comprises:
when performing the command sequence generation operation on the current read command group among the plurality of read command groups, checking a next read command group sorted after the current read command group to obtain the plane pointed to by each of one or more next second read commands in the next read command group and a working state of the plane, wherein the working state comprises an idle state and a busy state; and
adjusting a processing order of the one or more next second read commands according to the working state of the plane pointed to by each of the one or more next second read commands.

7. The data reading method according to claim 6, wherein a step of obtaining the plane pointed to by each of the one or more next second read commands in the next read command group and the working state of the plane comprises:
if a first plane pointed to by one of the one or more next second read commands is not pointed to by the one or more current second read commands in the current read command group, determining that the working state of the first plane is the idle state; and
if a second plane pointed to by one of the one or more next second read commands has been pointed to by the one or more current second read commands in the current read command group, determining that the working state of the second plane is the busy state.

8. The data reading method according to claim 7, wherein a step of adjusting the processing order of the one or more next second read commands comprises:
prioritizing processing of a target next second read command corresponding to the first plane in the idle state among the one or more next second read commands.

9. The data reading method according to claim 5, wherein the method further comprises:
when performing the command sequence generation operation on the current read command group among the plurality of read command groups, checking a next read command group sorted after the current read command group to obtain the plane pointed to by each of one or more next second read commands in the next read command group and a working state of the plane, wherein the working state comprises an idle state and a busy state;
obtaining a target next second read command corresponding to a target plane that is in the idle state among the one or more next second read commands;
generating a target read trigger command, a target polling command, and a target data access command corresponding to the target next second read command;
inserting the target read trigger command into the first command sequence; and
inserting the target polling command and the target data access command after the first command sequence.

10. The data reading method according to claim 5, wherein the method further comprises:
when performing the command sequence generation operation on the current read command group among the plurality of read command groups, checking a next read command group sorted after the current read command group to obtain the plane pointed to by each of one or more next second read commands in the next read command group; and
when a target plane pointed to by a target next second read command among the one or more next second read commands is different from all the planes respectively corresponding to all the current second read commands,
generating a target read trigger command, a target polling command, and a target data access command corresponding to the target next second read command;
inserting the target read trigger command into the first command sequence; and
inserting the target polling command and the target data access command after the first command sequence.

11. The data reading method according to claim 5, wherein a step of generating the read trigger command, the polling command, and the data access command corresponding to each current second read command according to the processing order of the one or more current second read commands of the current read command group comprises:
generating a first read trigger command corresponding to each current second read command one by one according to the processing order of the one or more current second read commands;
generating a pair of a first polling command and a first data access command corresponding to each current second read command one by one according to the processing order of the one or more current second read commands; and
for the one or more current second read commands, store their one or more first read trigger commands and one or more pairs of first polling commands and first data access commands as the first command sequence in the execution command sequence.

12. The data reading method according to claim 11, wherein a step of storing the generated first command sequence into the execution command sequence comprises:
checking whether there is a previous read command group sorted before the current read command group;
if the previous read command group exists, performing the following steps:
obtaining a second command sequence of the previous read command group, wherein the second command sequence comprises one or more second read trigger commands and one or more pairs of a second polling command and a second data access command corresponding to one or more previous second read commands of the previous read command group;
inserting the one or more first read trigger commands respectively after the second data access commands corresponding to a same plane in sequence according to the processing order of the one or more current second read commands; and
storing the one or more pairs of the first polling command and the first data access command in sequence according to the processing order of the one or more current second read commands.

13. The data reading method according to claim 5, wherein performing the command sequence generation operation on the plurality of read command groups comprises:
performing a command conversion on each second read command of each read command group according to the compilation order of the plurality of read command groups, wherein the command conversion comprises generating a read trigger command, a polling command, and a data access command according to a corresponding second read command,
wherein, for the current read command group on which the command conversion is being performed:
generating a read trigger command corresponding to the current second read command for each current second read command of the current read command group on which the command conversion has not yet been performed;
generating a corresponding polling command and a data access command for each read trigger command;
for each read trigger command, obtaining the plane corresponding to the read trigger command, and checking whether there is a target read command pointing to a same plane in a next read command group;
if the target read command pointing to the same plane exists, generating a corresponding target read trigger command based on the target read command of the next read command group, inserting the target read trigger command after the data access command corresponding to the read trigger command, and generating a target polling command and a target data access command corresponding to the target read trigger command; and
if the target read command pointing to the same plane does not exist, completing the command conversion for all current second read commands of the current read command group, and taking the next read command group as a new current read command group to perform a corresponding command conversion,
wherein if it is checked that the next read command group does not exist, completing generation of the execution command sequence.

14. The data reading method according to claim 5, wherein performing the command sequence generation operation on the plurality of read command groups comprises:
performing a command conversion on each second read command of each read command group according to the compilation order of the plurality of read command groups, wherein the command conversion comprises generating a read trigger command, a polling command, and a data access command according to a corresponding second read command,
wherein, for the current read command group on which the command conversion is being performed:
performing the command conversion on each current second read command of the current read command group on which the command conversion has not yet been performed, comprising:
if a read trigger command of a current second read command on which the command conversion is being performed has not yet been generated, generating a read trigger command corresponding to the current second read command, and generating a corresponding polling command and a data access command for the read trigger command;
if the read trigger command of the current second read command on which the command conversion is being performed has already been generated, generating a corresponding polling command and a data access command for the read trigger command;
after generating the corresponding polling command and the data access command, obtaining the plane corresponding to the read trigger command, and checking whether there is a target read command pointing to a same plane in a next read command group;
wherein if the target read command pointing to the same plane exists, generating a corresponding target read trigger command based on the target read command of the next read command group, inserting the target read trigger command after the data access command corresponding to the read trigger command, and completing the command conversion of the current second read command; and
wherein if the target read command pointing to the same plane does not exist, completing the command conversion of the current second read command, setting a next read command group as a new current read command group, and repeating the above steps to perform the command conversion on a new current read command.

15. A memory controller for controlling a storage device configured with a rewritable non-volatile memory module, the memory controller comprising:
a memory interface control circuit, for electrically connecting to the rewritable non-volatile memory module;
a data management circuit, electrically connected to a connection interface circuit of the storage device, for receiving data and commands from a host system via the connection interface circuit;
a buffer memory, for caching data; and
a processor, electrically connected to the memory interface control circuit, the data management circuit, and the buffer memory, wherein the processor is configured to:
store a plurality of read commands from the host system into one or more cache pools of the buffer memory respectively, wherein the one or more cache pools respectively correspond to different chip enable pins, and all read commands in each cache pool point to the chip enable pin corresponding to the cache pool to which it belongs;
when a preset condition is met, perform a pre-sorting operation on a plurality of first read commands in a first cache pool among the one or more cache pools to group the plurality of first read commands into a plurality of read command groups, wherein one or more second read commands belonging to a same read command group respectively correspond to different planes of the storage device of the rewritable non-volatile memory module, and memory cells corresponding to each of the one or more second read commands belong to a same memory cell type;
generate an execution command sequence corresponding to the first cache pool according to the plurality of read command groups of the first cache pool; and
execute a plurality of commands in the generated execution command sequence according to the generated execution command sequence to complete a parallel read operation corresponding to the plurality of first read commands.

16. The memory controller according to claim 15, wherein the preset condition comprises at least one of the following:
a number of the plurality of first read commands stored in the first cache pool reaches a predetermined threshold; or
a waiting time of a first read command earliest stored in the first cache pool reaches a predetermined time threshold.

17. The memory controller according to claim 15, wherein the processor is further configured to:
obtain a physical address of each read command according to recorded mapping information; and
obtain physical characteristics of the physical address of the read command according to the physical address of the read command, wherein the physical characteristics comprise the chip enable pin, the plane, a chip, and the memory cell type.

18. The memory controller according to claim 17, wherein a step of performing the pre-sorting operation comprises:
grouping the plurality of first read commands according to the memory cell type corresponding to each of the plurality of first read commands to obtain one or more memory cell type command groups, wherein one or more first read commands belonging to a same memory cell type command group correspond to a same memory cell type;
grouping the one or more first read commands within the same memory cell type command group according to the chip corresponding to each of the one or more first read commands within the same memory cell type command group to obtain one or more chip command groups, wherein one or more first read commands belonging to a same chip command group correspond to a same chip; and
compiling one or more second read commands respectively pointing to different planes within each chip command group into a same read command group to obtain the plurality of read command groups, wherein a processing order of the one or more second read commands within each read command group is set based on an order of corresponding planes.

19. The memory controller according to claim 18, wherein a plurality of commands within the execution command sequence comprise the following types: a read trigger command, a polling command, and a data access command, and wherein a step of generating the execution command sequence comprises:
performing a command sequence generation operation on each read command group in sequence according to a compilation order of the plurality of read command groups,
wherein when performing the command sequence generation operation on a current read command group among the plurality of read command groups, generating the read trigger command, the polling command, and the data access command corresponding to each current second read command according to a processing order of one or more current second read commands of the current read command group to obtain a first command sequence corresponding to the current read command group; and
storing the generated first command sequence into the execution command sequence.

20. The memory controller according to claim 19, wherein the processor is further configured to:
when performing the command sequence generation operation on the current read command group among the plurality of read command groups, check a next read command group sorted after the current read command group to obtain the plane pointed to by each of one or more next second read commands in the next read command group and a working state of the plane, wherein the working state comprises an idle state and a busy state; and
adjust a processing order of the one or more next second read commands according to the working state of the plane pointed to by each of the one or more next second read commands.
